(19) United States
(12) Patent Application Publication
(10) Pub. No.: US 2011/0184998 A1
(43) Pub. Date: Jul. 28, 2011

(54) UNIVERSALLY ACCESSIBLE ENCRYPTED INTERNET FILE SYSTEM FOR WIRED AND WIRELESS COMPUTING DEVICES SUPPLANTING SYNCHRONIZATION, BACKUP AND EMAIL FILE ATTACHMENT

(76) Inventors: Samuel L. Palahnuk, (US); Catherine M. Newman, (US)

(21) Appl. No.: 13/010,490

(22) Filed: Jan. 20, 2011

Related U.S. Application Data
(60) Provisional application No. 61/297,650, filed on Jan. 22, 2010.

(51) Int. Cl. G06F 17/30; G06F 15/16

(52) U.S. Cl. 707/827; 707/E17.01

(57) ABSTRACT

This Internet based file system allows various wired and wireless computation devices such as personal computers, laptop computers, tablet computers, cell phones, and any other Internet connected devices to manage their files in their native method, however, the invention inserts itself into the operating system and creates a caching and encrypting system that maintains the files on an Internet server.

All registered devices share the same files, supplanting the need for file and data synchronization, and backing up files. Many users may belong to this service, a user of the system may “share” any or all of their files (data) with any other user of the system, allowing instant access to that user, which supplants the need for email attachments, large file-sending websites or the sending physical media.

Invention also includes the ability to stop data to devices when they're lost or stolen, data inheritance, restoring lost data and moving data from the Internet server onto physical storage mediums.

### CROSS-REFERENCE TO RELATED APPLICATIONS

Related to Provisional Patent Application No. 61/297,650. Docket number THYNSYN-001 PCT.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

When consumers purchase personal computing and communications devices such as personal computers, cellular phones, and laptop computers, the primary purpose of the purchase is to create various computer files, such as emails, text messages, contact lists, and various application files such as Microsoft Word documents, PowerPoint presentations, etc. They also utilize their computing devices for the storage of video files and music files, either self-created or purchased. Often these files are created with the intention of sending that file to other people or sharing it with a group of people. Consumers simply assume that the hardware and software manufacturers will provide the tools needed to convey that data between the devices (data migration, conversion, and synchronization between devices), to back up that data (save that data on another separate storage medium), and to send that data efficiently between various users (typically done with email file attachments). The unfortunate truth is that it is not in the best interests of the hardware manufacturers or software manufacturers to provide these services. The hardware manufacturers are interested in selling new hardware, and the software manufacturers are interested in selling the newest version of their software. There is little incentive for manufacturers to make it easy for consumers to move their data to other devices that are not made by them, or back up the data, unless doing so allows them to profit by selling additional equipment and/or software.

This leaves a terrible burden on users to cobble together a solution for backing up, sharing and synchronizing their data between their devices, often utilizing media based or online backup for document files, a separate backup and synchronization process for mobile devices, and a method of sending files to others that includes email, file sharing, and specialty websites like mailbigfile.com, dropsend.com, and transferbigfiles.com. Because no single solution is available, users often own and operate several separate software programs such as sync programs and backup programs, and the burden is on them to remember to do these tasks on a regular basis or suffer terrible cost and time penalties when devices are lost or stolen or spend hundreds of dollars having data recovered from crashed hard disks. For this reason users often end up having different data on different devices (such as Bob's phone number on their cell-phone but Bob's address in Microsoft Outlook on their PC), some devices backed up and others not, and when backups can be found they're often so old, recovering and restoring data can be as large a task as rebuilding the data from scratch.

What is needed is a single system that allows consumers to transparently, automatically, and effortlessly work on their computer files including emails, contacts, and calendars, which emanate from a single, secure, incorruptible, uninterruptable source; and regardless of what device they are using, access those files on any borrowed or new device, never worry about losing those files due to a hardware failure such a hard disk crash or loss/damage/destruction of a device, and easily send those files to anyone they choose.

Although it is possible for consumers to cobble together a piece-meal solution to this complex problem by using various “sync” programs, on-line backup services, and online services which allow sharing and delivery of large files, this method is expensive, inconsistent, and only provides a partial solution to the problem. Therefore, an improved universal file system is needed to allow users to share, access, secure, and deliver their data.

### BRIEF DESCRIPTION OF DRAWINGS

FIG. 1 shows one exemplary block diagram of the system.

FIG. 2 is an exemplary process of the file interceptor.

FIG. 3 is an exemplary process of master file manager.

FIG. 4 is an exemplary process of file manager file handler.

FIG. 5 is an exemplary process of command handler

FIG. 6 is an exemplary process of file maintainer

FIG. 7 is an exemplary process of connect manager

FIG. 8 is an exemplary process of server data manager

FIG. 9 is an exemplary process of shutdown postponer

FIG. 10 is an exemplary process of file determiner.

FIG. 11 is an exemplary screen map of a user interface of a file determiner with no sharing.

FIG. 12 is an exemplary screen map of a user interface of a file determiner with sharing.

FIG. 13 is an exemplary screen map of the widget with syncing in process.

FIG. 14 is an exemplary screen map of the widget with syncing complete.

FIG. 15 is an exemplary screen map of the widget with file history revealed

FIG. 16 is an exemplary screen map of the widget with actions revealed

FIG. 17 is an exemplary screen map of the widget with contacts revealed

FIG. 18 is an exemplary process of automatic contact updating.

FIG. 19 is an exemplary process of data to go functionality.

FIG. 20 is an exemplary process of stolen device data stop functionality.

FIG. 21 is an exemplary process of data inheritance.

FIG. 22 is an exemplary process of emergency restore functionality.

FIG. 23 is an exemplary process of encryptor functionality.

FIG. 24 is an exemplary process of file open, edit and view assistance functionality.

FIG. 25 is an exemplary process of security check trigger functionality.

FIG. 26 is an exemplary screen map of the website user interface layout.

FIG. 27 is an exemplary screen map of the file sub-screen of the website user interface layout.

FIG. 28 is an exemplary screen map of the contacts sub-screen of the website user interface layout.

FIG. 29 is an exemplary screen map of the emails sub-screen of the website user interface layout.

FIG. 30 is an exemplary screen map of the calendar sub-screen of the website user interface layout.

FIG. 31 is an exemplary screen map of the sharing sub-screen of the website user interface layout.

FIG. 32 is an exemplary screen map of the history sub-screen of the website user interface layout.

FIG. 33 is an exemplary screen map of the vault sub-screen of the website user interface layout.

FIG. 34 is an exemplary screen map of the data to go sub-screen.

FIG. 35 is an exemplary screen map of the emergency restore sub-screen.

FIG. 36 is an exemplary screen map of the stolen device data stop sub-screen.

FIG. 37 is an exemplary screen map of the data inheritance sub-screen.

FIG. 38 is an exemplary screen map of the settings sub-screen.

FIG. 39 is an exemplary screen map of the account information sub-screen.

Throughout the drawings and the detailed descriptions, like reference numerals refer to the like elements.

### SUMMARY OF THE INVENTION

By installing special software on each of a consumer's various Internet connected mobile and non-mobile computing devices, this invention supersedes those devices' primary storage devices (such as hard disks) and supplements them with a managed and cached data stream via the wired or wireless connection to the Internet and then to a cloud-computing based Internet server where a single source is created for each and every computer data file the user has, regardless of which device that file originated from.

This single source of data files is, in like manner, transmitted and shared with all of the other computing devices, thus effectively synchronizing the data; and furthermore, files can be “sent” to other persons simply by sharing that single source with them by granting them access to that same file rather than sending that file via file attachment or specialty large file sending web-service. This is particularly effortless because the software also aggregates all of the user's contact information, making the “sending” of the file a simple matter of selecting a contact or contacts' names from a list or group and associating them with the selected file.

The software installed on each device utilizes that device's random access memory and primary storage device to create a cache of the most recently used files and assures that any files are immediately or eventually copied onto a cloud-computing based Internet server. This is done to create a de-facto backup of the data, and to assure that in most cases the users have instant access to their data files.

Multiple layers of data encryption and data handling protocols ensure that files are always stored in multiple locations to assure no data is ever lost, and that files are encrypted in transit and double encrypted when data is of a highly sensitive nature. Unique functionalities become available with this new method of storing, sharing and synchronizing data files. These functions will include granting users the ability to copy server based data onto various forms of storage mediums should they wish to access that data when Internet access is not practical or desired; the ability to completely restore a device's data to a last known good state should that device suffer damage or be replaced with a new device; the ability to stop the flow of data to a device that has been lost or stolen and even prevent that device from being used in future; the capacity for valuable data to be instantly and fully available to a beneficiary or relative in the event of a device/data owner's passing; the ability to effortlessly maintain consistency and completeness in contact databases by assuring that all contacts are shared with all devices and that all disparate elements of each contact are assembled into a more complete record; the ability to collect information from the user's various computerized/online calendars and access that data from any and all user devices and even combine that data into one definitive calendar; the ability to share any data or collections of data with any person or group of persons, controlling the recipient's ability to only review that data or granting them permission to edit the data; the ability to see the complete transit history of each data file so that the user can know who has received, reviewed, or changed each file; and a special “vault” location featuring double encryption and security so the user can protect their most valuable data such as credit card numbers, safe combinations, digitized documents, family photographs, videos and sound recordings safe from natural disasters and other threats; and finally an inherent feature that assists the user in accessing a file to view, edit or print it on a new or borrowed computer or device even if the software that that file was created with is not present; for example: being able to print a Microsoft Visio file utilizing a rented laptop computer without having to buy and install Visio on that device.

### DETAILED DESCRIPTION OF THE PREFERRED EMBODIMENT

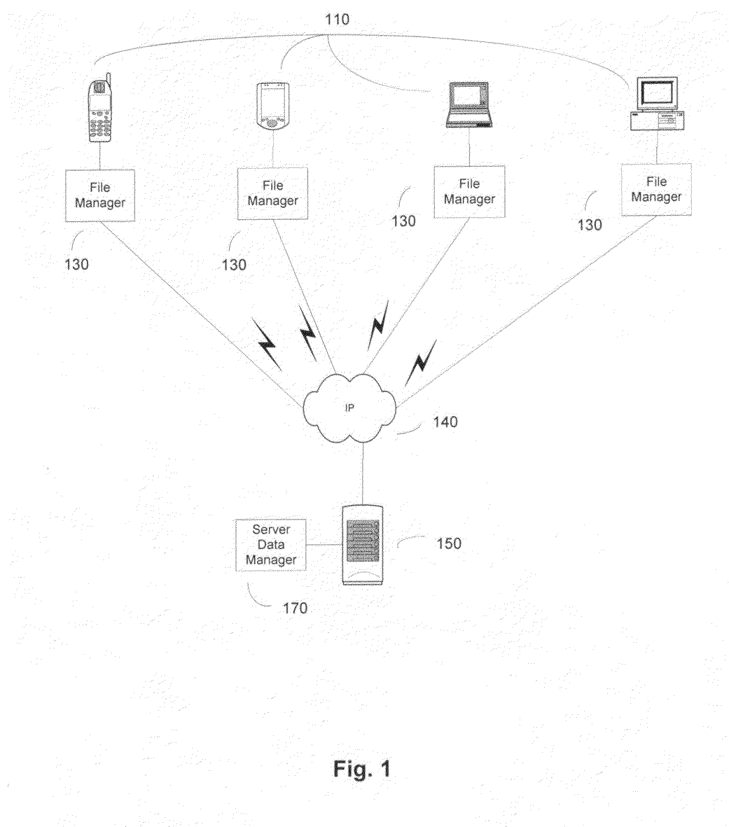

Referring to the Figures, computing devices both portable and non-portable 110 in FIG. 1, shown here as a cell-phone with Internet connectivity, an Internet connected tablet computer or personal digital assistant, a laptop or netbook computer, and a traditional desktop computer. These portable and non-portable computing devices are each attached to a file manager 130 which supersedes that device's normal access to its native storage mechanism, be that random access memory, a hard disk, Electrically Erasable Programmable Read-Only Memory, static random access memory or other primary data storage medium. The file manager maintains a connection via wireless or wired connection to the Internet 140 and caches, and encrypts the data files. A cloud based web server 150 connects the Internet data stream to a server data manager program 170 which un-encrypts files and stores them in multiple redundant locations on banks of hard disks and other storage mediums, thus backing them up and making them available for sharing and as “attachments”.

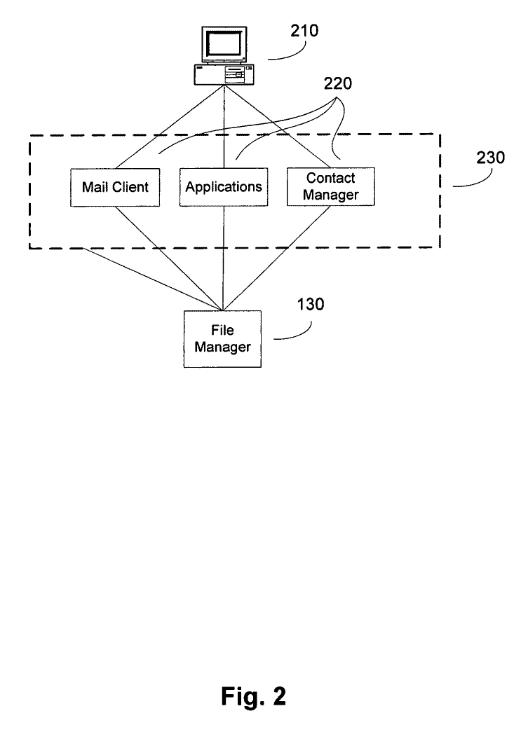

In addition to the file manager 130, installation of the software includes a file interceptor shown in FIG. 2. This software resides between the user's computing device 210 and the file manager 130. The purpose of this software is to intercept the normal read and write commands performed by the device's operating system, such as Microsoft Windows, Macintosh OS X, Palm OS, Windows Mobile, Android, and iOS, and redirect certain operations 230 to the file manager, and still let other commands operate unaffected. Certain software, such as the user's email client applications, such as Microsoft Word, and their contact manager, such as Microsoft Outlook produce files which many users may want to share, backup, or synchronize between their devices, so these files are intercepted and sent to the file manager 130. Other read/write operations that users are less likely to want to share, back up or synchronize between devices, such as caching performed by web browsers like Internet Explorer or Firefox, changes to screen saver settings and loading of video games are not intercepted or dealt with by the system.

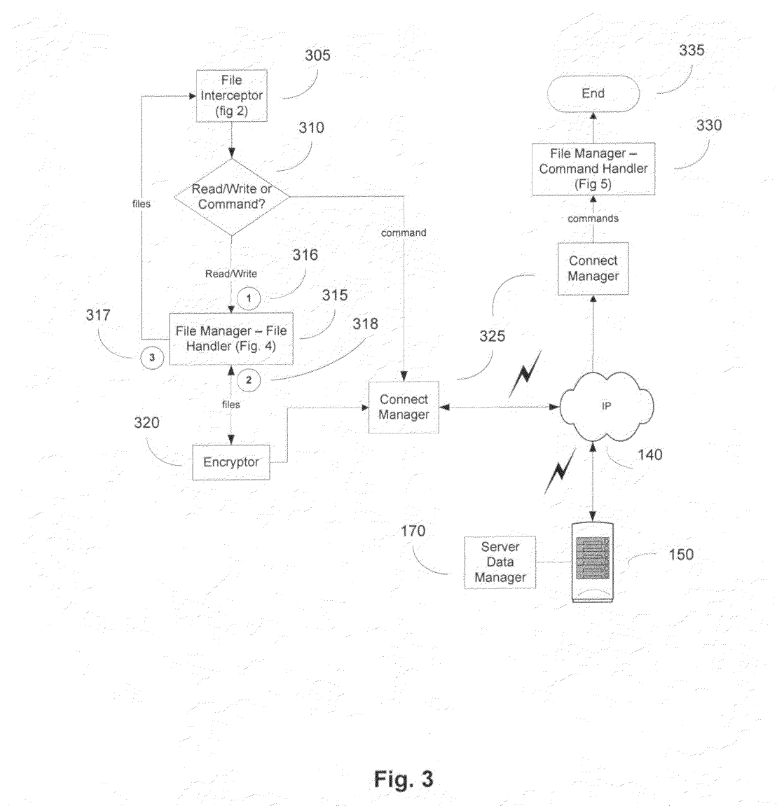

The file manager in FIG. 3 sends and receives its data to and from the computing device via the file interceptor described in FIG. 2 and maintains a link to the cloud-based web server 170 via a wired or wireless Internet connection 140. In a general sense, the file manager maintains a virtual drive on the user's computing device, so that its function is invisible to the user and the user may continue to use the computing device exactly as before. The files on this virtual drive are maintained by the file manager via a combination of that device's existing primary storage medium, random access memory, and the writing and reading of data from the cloud-based web server via the internet.

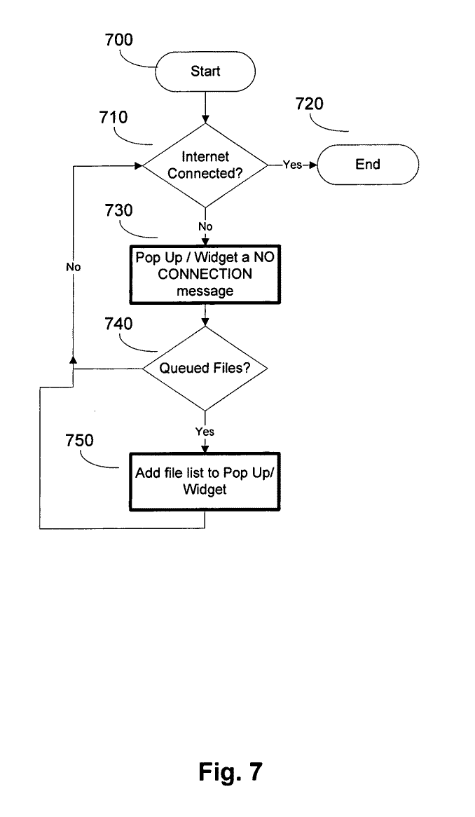

From the computing device's perspective, the file manager sends and receives data from the file interceptor described in FIG. 2 as in 305 and more completely in FIG. 3. The data received is evaluated to see if it is a special command or a data file in 310. Commands are transferred to the connect manager 325 (later described in FIG. 7) which simply sends those commands directly to the cloud-based web server 150 via the wired or wireless Internet connection 140.

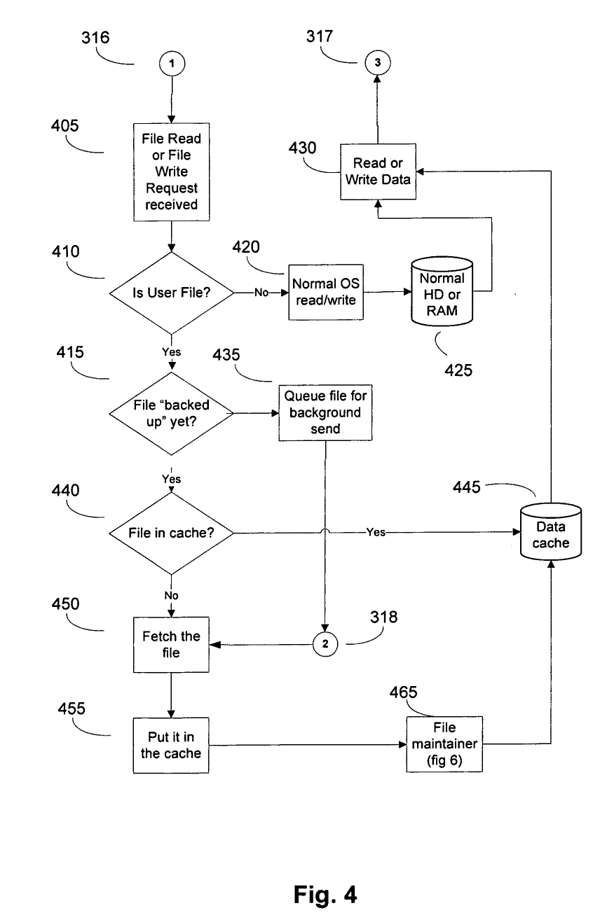

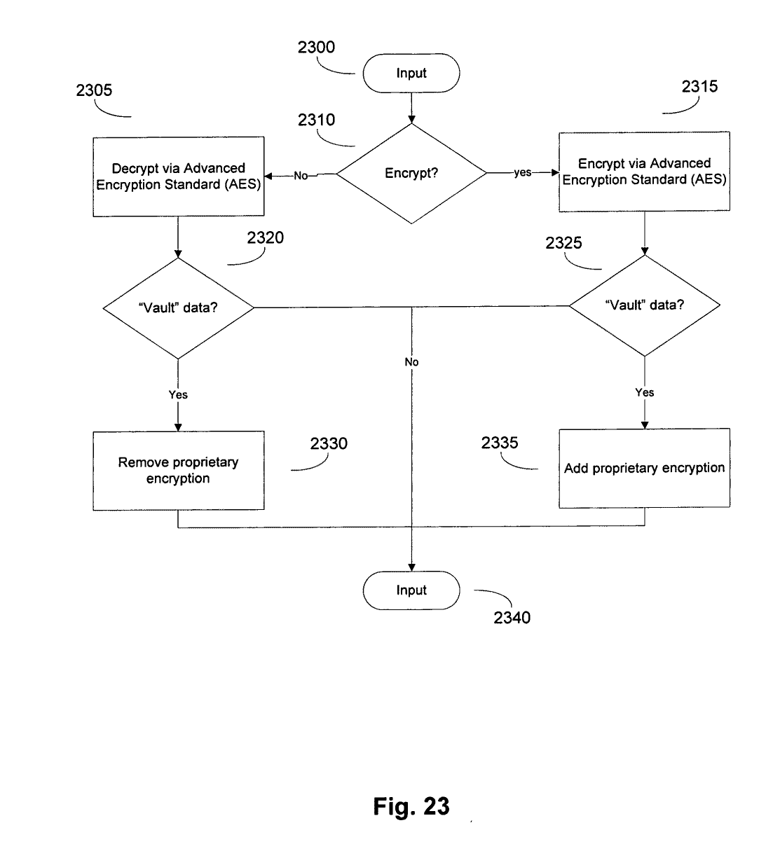

Read/write data (files) are routed to the file manager—file handler 315 described in FIG. 4. Read/write requests are handled by data port (1) 316, files are routed to the Internet via port (2) 318, and sent back out to the file interceptor via data port (3) 317. Data from data port (2) 318 passes through the encryptor 320 (described in FIG. 23) which utilizes the Advanced Encryption Standard (AES) encryption algorithm, or the currently most secure and widely respected industry standard, then that encrypted data is sent/received to/from the cloud-based Internet server 150 via a wired or wireless connection to the Internet 140.

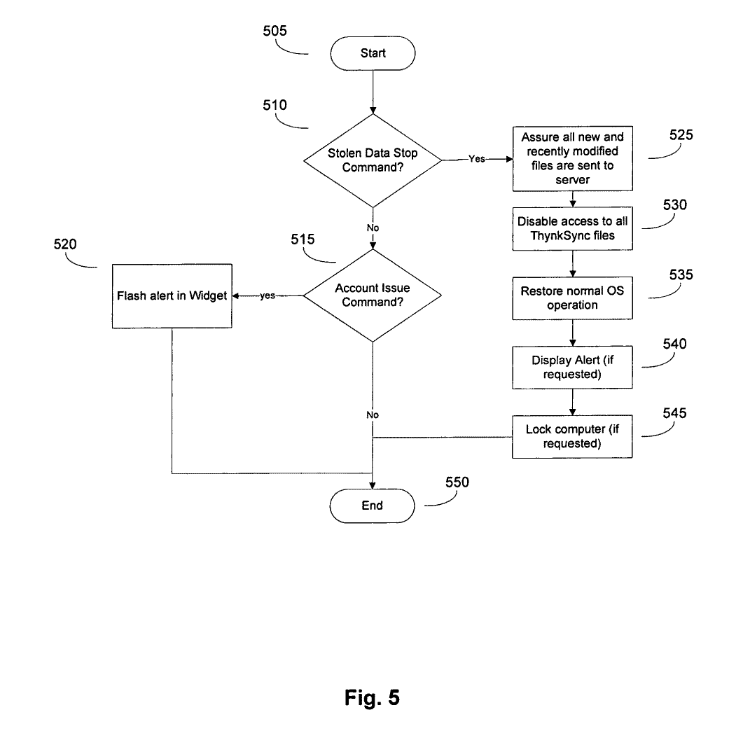

Commands are also received by the file manager for use in that particular computing device via the Internet connection 140 which are managed by the connect manager 325 and then delivered to the file manager—command handler described in FIG. 5. Operation ends at 335.

The function of the encryptor 320 is fully described in FIG. 23. Function begins at 2300 where the first branch point is to determine if the file must be encrypted or decrypted 2310. If decryption is requested, then the file is decrypted via the open source Advanced Encryption Standard (AES) encryption algorithm, or the currently most secure and widely respected standard 2305. If the data is to be stored in the software's “vault” area 2320, then an additional level of proprietary encryption is removed 2330 and functionality ends at 2340.

If instead, encryption is called for in 2310, then the file is encrypted via the open source Advanced Encryption Standard (AES) encryption algorithm, or the currently most secure and widely respected standard 2315. If the data is to be stored in the software's “vault” area 2325, then an additional level of proprietary encryption is added 2335 and functionality ends at 2340.

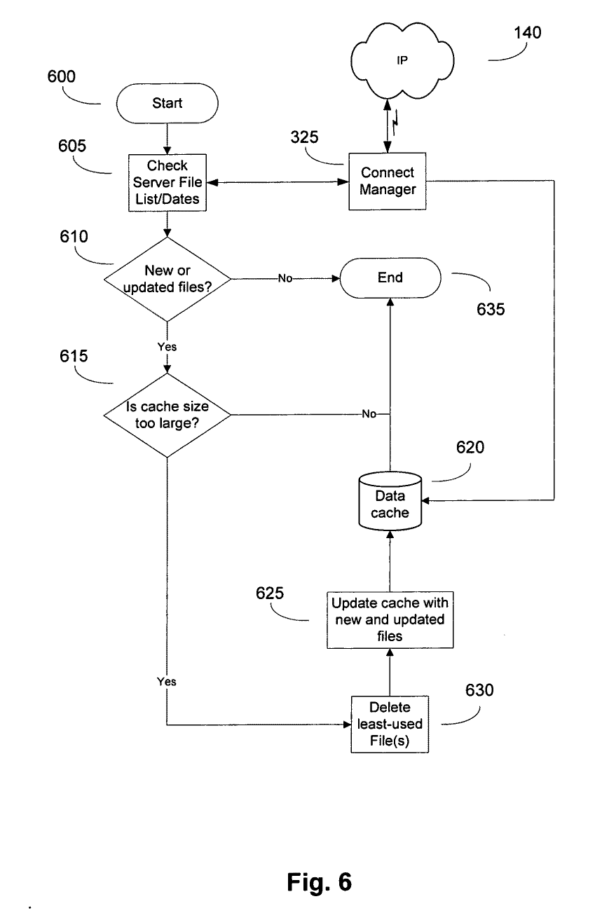

FIG. 4 describes operation of the file manager—file handler. Data is received through data port (1) 316 from the file manager—master via 405. The software checks to see if the data is a user file 410. If it's not, the file is handled by the device's normal operating system 420 and stored on that device's primary storage device 425, then that data is read or written 430 and send to data port (3) 317. If the data is indeed a user file as per 410, then the system checks to see if that file has already been backed up 415. If it hasn't been, then that data is queued 435 to be sent to the cloud-based Internet server so it can be sent as a background task via data port (2) 318. If the file has been backed up via 415 then the system checks to see if that data is already in the cache 440. If it is, that data is fetched from the cache 445 and sent via 430 to data port (3) 317. If the data is not cached then the system fetches the file from the cloud based Internet server via 450 and data port (2) 318. Once fetched, the file is placed in the cache 455, then that cache is maintained by the file maintainer 465 (described in FIG. 6), placed in the cache itself 445, then sent via 430 and finally data port (3) 317.

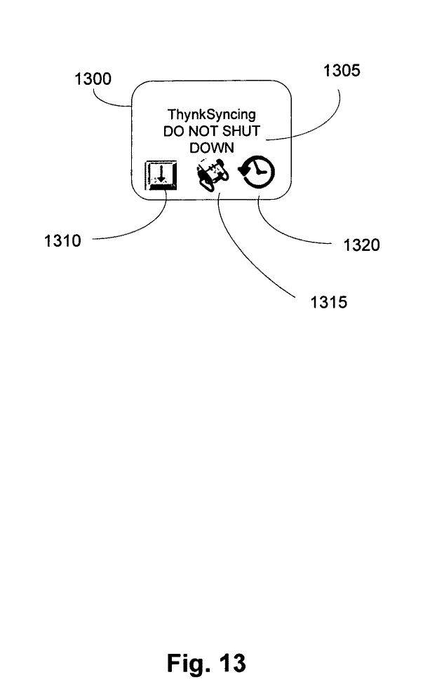

When the file manager described in FIG. 3 requires the handling of commands, those commands are sent to the command handler described in FIG. 5. Processing starts at 505, then the software checks to see if the command is a request for this computing device to perform a “stolen device data stop” 510, which is a command sent by the user to a device that has been lost or stolen. This particular command causes the file manager to deny access to the user's data, both in the cache and via the Internet stream to the cloud-based Internet server, and can display alerts to the screen and also lock up the device, preventing its use in any way. If the command from the server is indeed a stolen data stop command, then the first step the software takes is to make sure all cached files are sent to the cloud-based Internet server 525, then the system disables all accessibility to files both in the cache and via the Internet data stream 530, then the system disables the file interceptor described in FIG. 2 restoring normal operation 535. If the command sender has requested an alert be placed on the screen, then that alert is displayed 540 and if the command sender has chosen to lock up operation of that computing device, then that happens at 545 ending operation at 550. Another kind of command is an alert regarding the user's account information, such as needing to update a credit card, that they have exceeded their data storage allotment, or that a device is thought to have been stolen. These textual alerts are recognized at 515 and displayed in the software's “widget” which is described in FIG. 13, via 520. The file manager—file handler utilizes a subroutine called file maintainer which is described in FIG. 6. The job of the file maintainer is to maintain the cache and handle background sending and receiving of files. The process begins at 600, where the software utilizes the connect manager 325 to check the data cache for a list of user files and those files' creation and modification dates 605. If the cache is found to not contain any new or updated files then operation ends at 635. If new or updated files are indeed found in the cache 610, then the system goes on to check if the cache size has grown larger than its designated maximum size in 615. If not, operation ends at 635. If it is, then least used files are deleted from the cache (but not from the Internet server database) 630 and the cache is updated with the new and updated files 625 in the cache itself at 620. The operation ends at 635.

The connect manager software described at FIG. 7 begins operation at 700. Initiated only when the file manager or other software needs to access the cloud-based Internet server, the job of the connect manager is to make sure the Internet is connected and available for the data to be transferred. The connect manager checks to see if the Internet connection is available 710 and if it is, it passes through the data stream and ends at 720. If an Internet connection is not available, a pop-up alert appears on the computing device's screen and, if present, on the widget with a “no connection” error message 730. Via 710 the connect manager continues to alert the user until a connection is made. If computer files are queued up in the cache 740, the software takes the extra step of creating a list of files in the widget that are waiting to be sent to the Internet server 750.

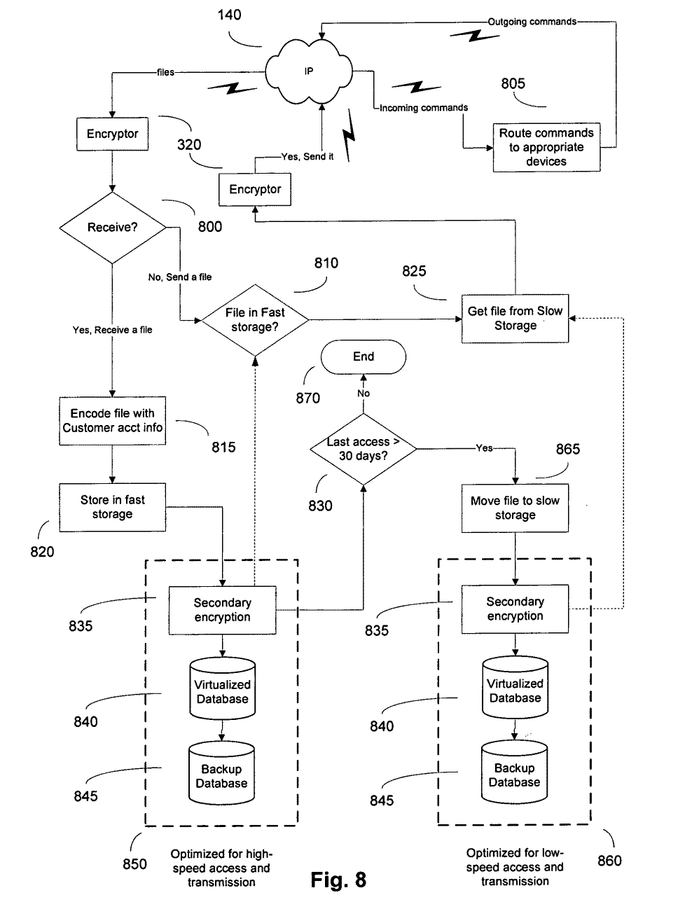

On the server side, software also exists called the server data manager described in FIG. 8. The purpose of this software is to manage all of the user's data into fast (FIG. 8, 850) and slow access storage (FIG. 8, 860) to assure that all user files are received, stored, delivered and encrypted for transparent functionality. The software also handles passing commands between the user's separate computing devices.

The data and commands arrive and depart via the Internet data stream 140. Incoming files are decrypted 320 and the software checks to see if the files are being received (rather than sent) 800. If yes, then they are encoded with customer account information 815, and stored in fast storage 820. Fast storage 850 contains additional file encryption for files set with “high security” and for those files saved in the “vault” 835, then they are stored in the virtualized hard disk storage array 835 and, via RAID system 840, they are also stored in a separate backup database 845.

If the file is not received 800, then it is a request to send a file. The system checks to see if the file requested is in fast or slow storage 810. If found in fast storage 850 it is fetched, encrypted 320 and sent to the file manager via the Internet stream 140. If the file is in slow storage, it is fetched from the slow storage area 860 and encrypted via 320 and also sent to file manager via the Internet stream 140.

If a file has not been accessed in more than 30 days 830, the system moves the file from fast storage 850 to slow storage 860 so as to reduce storage costs while still keeping frequently used files available quickly.

When a command is received, it is routed to the appropriate device 805 via the Internet stream 140.

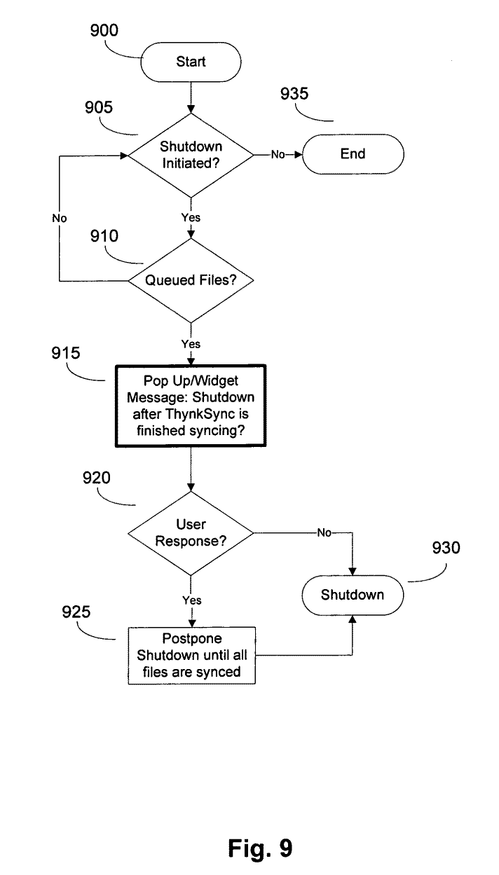

The software system does not force the user to wait for files to be written. It does this by transferring files in the background. For this reason it's possible for the user to try to shut down/turn off the computing device before all of the files have been sent to the Internet server. Handling this problem is the responsibility of the shutdown postponer diagramed in FIG. 9. This software runs continuously 900 monitoring the user's request for shutdown 905. If a shutdown is not detected, the functionality ends at 935 to repeat checking. If a user initiated shutdown is detected, then the system checks to see if there are any pending files in the queue that need to be sent to the Internet server 910. If not, the system continues checking for a future shutdown request 905. If queued files are waiting to be sent to the Internet server, then a pop up alert appears on the screen of the computing device 915 reading “Shutdown after ThynkSync is finished syncing?”. If the user responds “yes” 920 then the software postpones the shutdown 925 until the files are sent. If the user responds “no”, then operation ends 930 and the files are sent the next time the system is restarted. Some operating systems have a “sleep” state which allows programs and applications to continue to run even though the device seems to be “off”. In this case the system continues to send and receive data as if the system was “on”, and does not enter its “shutdown” mode.

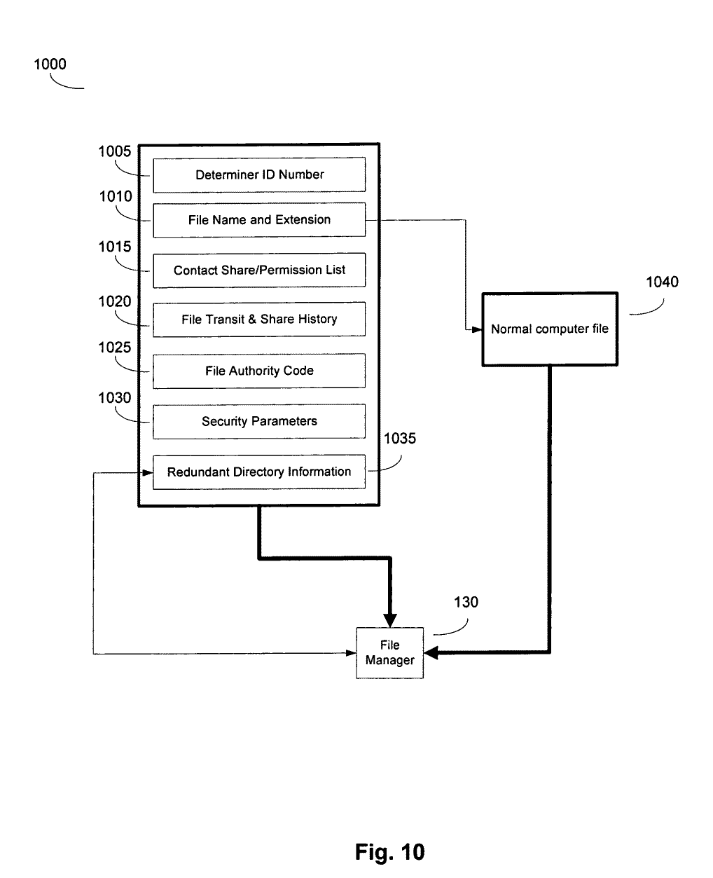

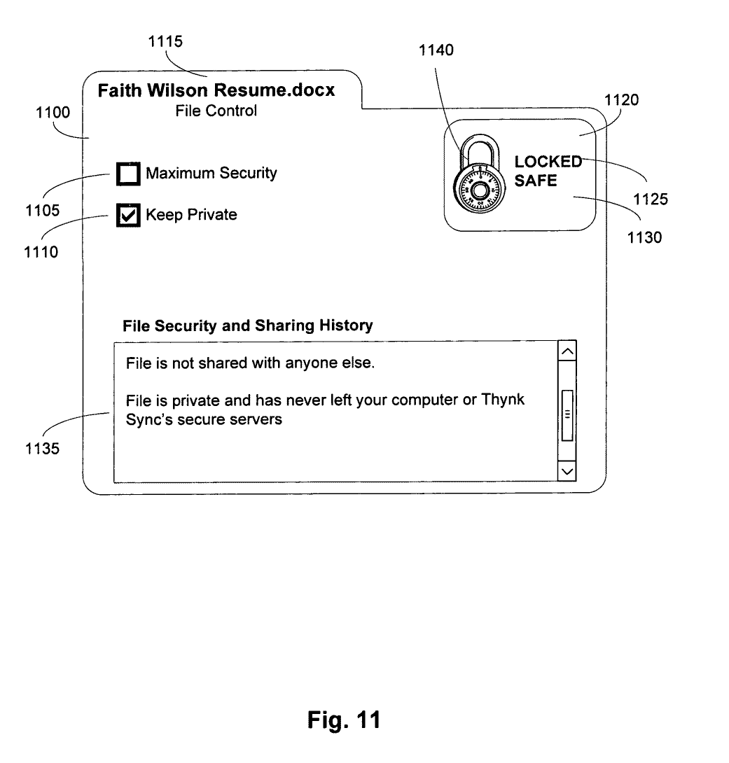

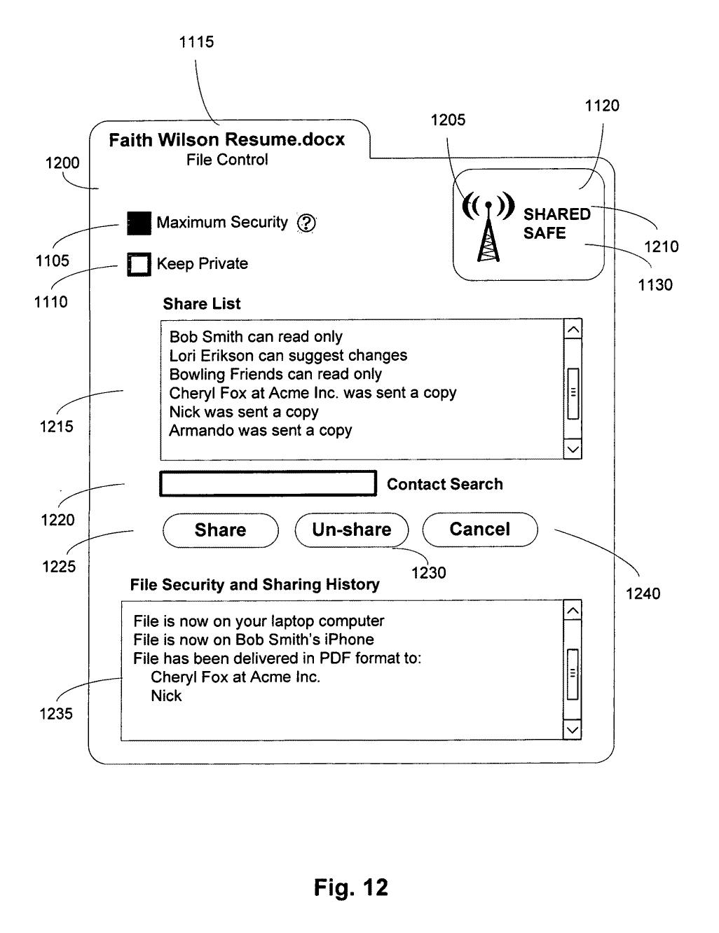

Because files managed by this software have additional characteristics (beyond what's normally found in a file system file header), this additional data is stored in the file determiner described in FIG. 10. The additional file descriptors 1000 include the determiner ID number 1005, the file name and extension 1010, the contact share/permission list 1015, the file transit and share history 1020, the file authority code 1025, the security parameters 1030, and lastly a redundant copy of the file's directory information 1035 which allows the software to aid in restoring lost files should the device's primary storage become damaged. These addition file descriptors are saved as regular computer files, hidden and protected from deletion by the file manager 130. The file name and extension 1010 are linked to the normal computer file 1040. These additional file characteristics are partially accessible to the user via the file determiner user interface—no sharing shown in FIG. 11. This interface can be launched by the widget, or by selecting the file in the device's normal operating system. When this user interface is launched a window opens 1100 titled with the name of the computer file in question 1115. A sub-window 1120 shows if the file is locked 1125 with an addition icon making the locked status very clear 1140. Locked files are not shared. The term “safe” 1130 appears in the sub-window indicating that since the file has never been shared, it has never been seen so therefore it's labeled “safe” by the software. The user may choose to change the settings for this file. By checking the “maximum security” box 1105 the user specifies that the file should receive double encryption. Un-checking this box applies only normal encryption. If the “keep private” box 1110 is checked, then the file is not to be shared and is therefore safe 1130. If the box is unchecked a share version of this window replaces it, as illustrated in FIG. 12. Also in this window is a file security and sharing history log 1135 listing any and all share history for the file.

If the user chooses to share the file by un-checking the keep private box 1110 then file determiner user interface—shared 1200 replaces the previous window as per FIG. 12. Like the previous window, the file name appears 1115 as does a status sub-window 1120. An antenna icon 1205 and the word “shared” 1210 also appear making it clear to the user that this file is no longer private.

The maximum security check box is “grayed out” 1105 as the file is now “out in the wild” can no longer be double encrypted. However, the user may choose to un-share the file by checking the “keep private” 1110 check box again. When a file is shared, a share list appears 1215 which is filled with a list of which users have access to the file, and what exact access they do have. In the contact search box 1220 the user may type the name of contacts and share the file with them by clicking on 1225, or un-share the file with them via the un-share button 1230. The entire operation can be cancelled by the user by clicking on the cancel button 1240.

Also in this window is a file security and sharing history list 1235 listing any and all share history for the file.

Certain computing devices feature operating systems that support “widgets” or “gadgets”, which are tiny programs that appear on the OS desktop. Examples include Windows Vista, Windows 7, and Macintosh OSX. A widget is provided by the software 1300 described in FIG. 13 through FIG. 17.

The purpose of the widget is to provide constant on-screen access to functions and messages. The widget window 1300 includes a situation dependent “do not shut down” message 1305, an action icon 1310, a contact icon 1315, and a history icon 1320.

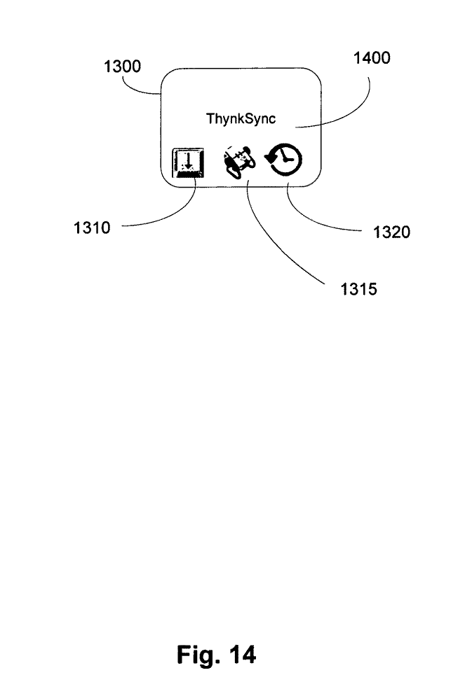

In FIG. 14 the “do not shut down” message 1305 has disappeared as the system has caught up on sending queued files 1400.

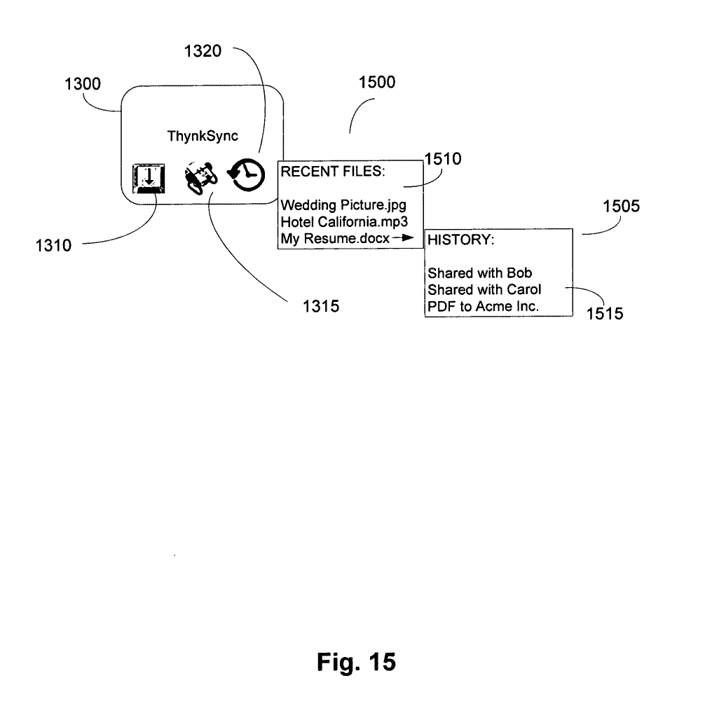

In FIG. 15 the history icon 1320 has been selected which caused the widget to open sub window 1500 which lists all recent files 1510. If the user selects one of these files, yet another sub-window opens 1505 which displays the history of that file 1515.

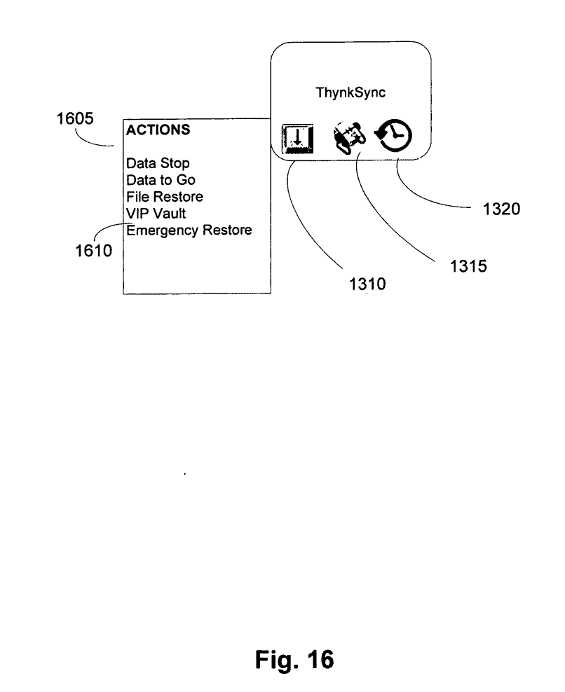

In FIG. 16 the user has selected the action icon 1310 causing a sub-window 1605 to open, listing all available commands the user may activate 1610.

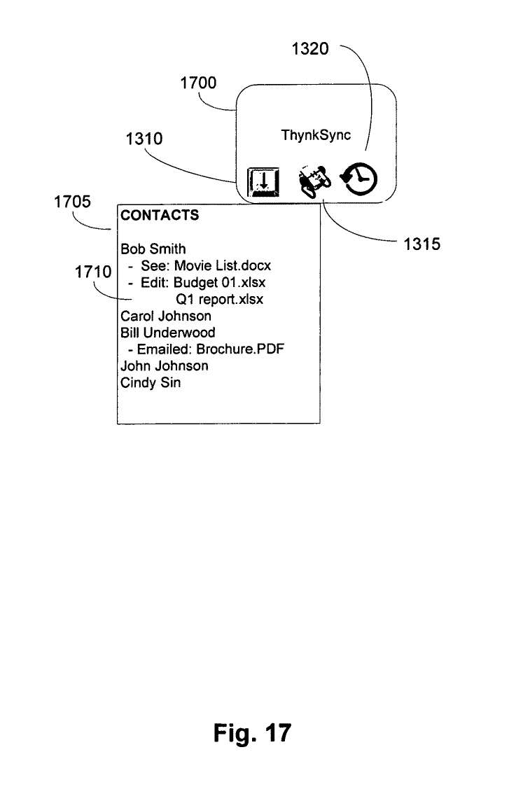

In FIG. 17 the user has clicked on the contacts icon 1315 causing a sub-window 1705 to open displaying a list of contacts 1710 and the files that are shared with them.

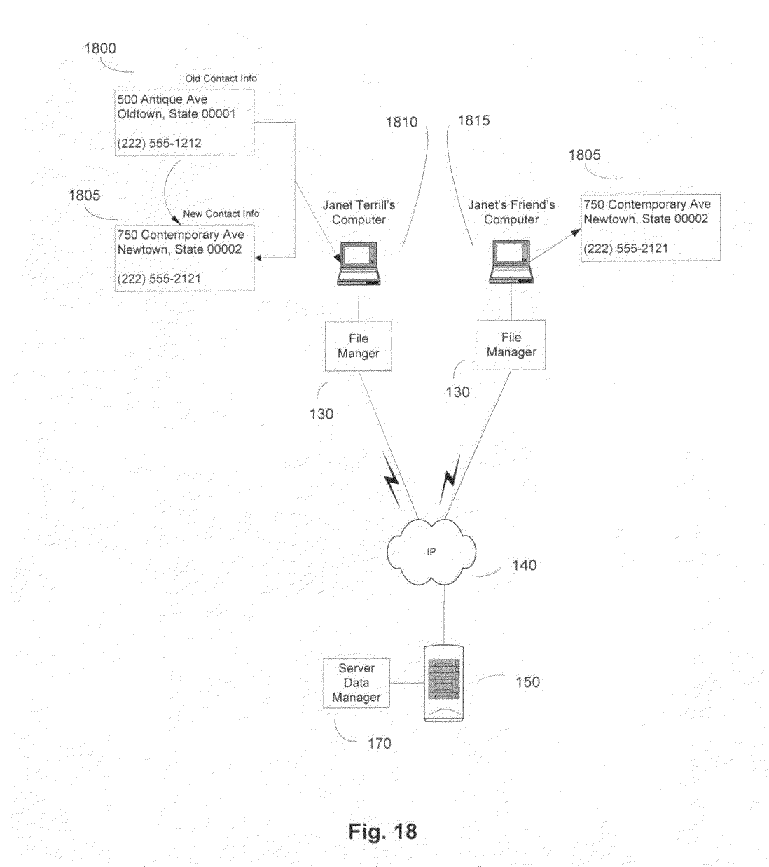

One of the advantages of having a single-source database is that users need only change their contact information in one place, and that data will be shared with all users of the software system. This system of automatic contact update is described in FIG. 18. In this case Janet Terrill updates her old contact information 1800 with new information 1805 on her computer 1810. The system operates as described in FIG. 1, moving that information to the cloud-based Internet server 150, and that data is eventually available to Janet's friend 1815 where she sees the new information “automatically” appear 1805.

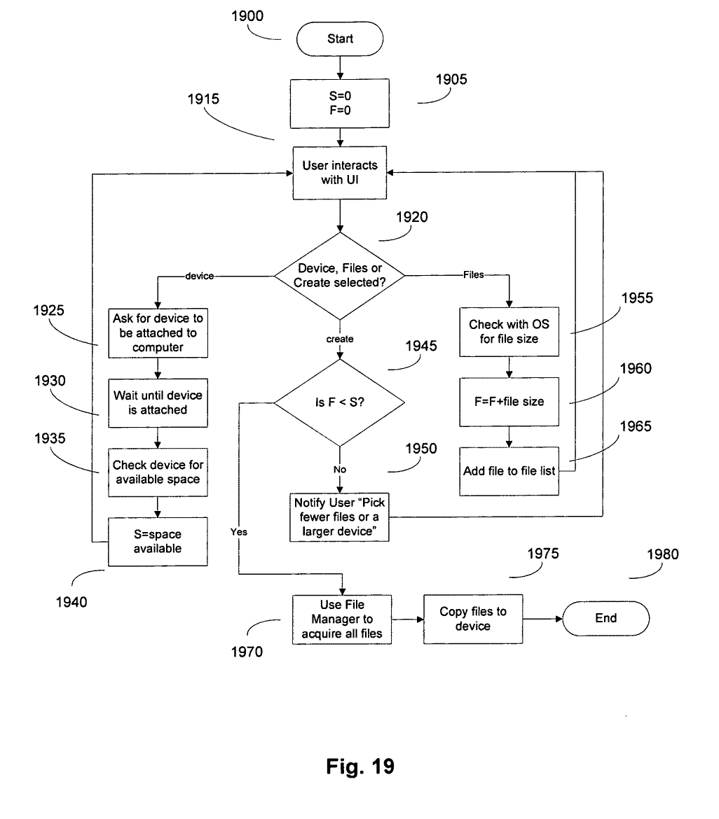

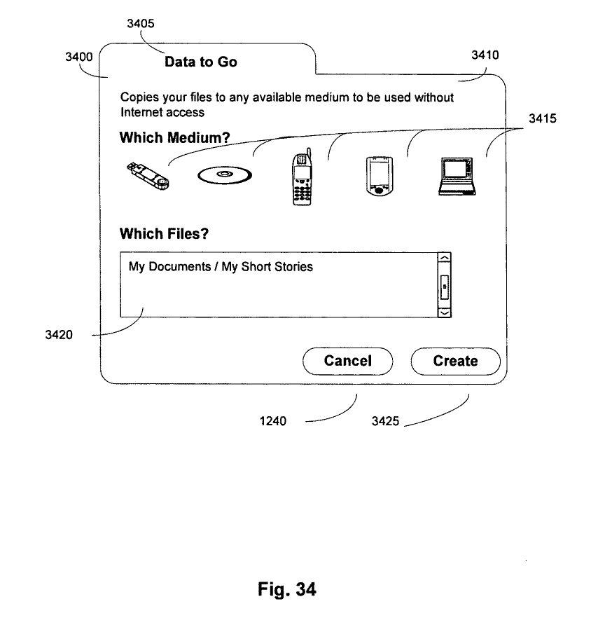

Another feature of this file system is the ability to transfer data from the cloud-based Internet server to a fixed media such as a flash drive, CD-ROM, DVD-ROM, portable hard disk, or other device when the user needs the information in a situation where an Internet connection is not practical. This function is described in FIG. 19. Function starts 1900, then a variable “s” is set to the value “0”, and a variable “f” is also set to the value of “0” 1905. The user then interacts with the user interface 1915 as seen in FIG. 34. If a target device is selected 1920 then the software asks the user to attach the device to the computer 1925, then waits until the device is actually connected 1930. The software then checks to see how much space is available on the device 1935. The variable “s” is then replaced with the value of the available space 1940. Operation returns to 1915. If at 1920 the user has selected a file instead, then the software checks with the operating system to determine the file size 1955, the variable “f” is incremented by the file size 1960 and the file name is added to the file list 1965. Operation returns to 1915.

If the user has instead selected “create” 1920 then the software checks to see if the files “f” fit in the available space “s” 1950. If yes, then the file manager is instructed to fetch the files 1970, those files are written to the inserted data storage medium 1975, then operation ends at 1980.

If the files “f” do not fit in the available space “s” 1950 then the user is notified to pick fewer files 1950 and operation returns to 1915.

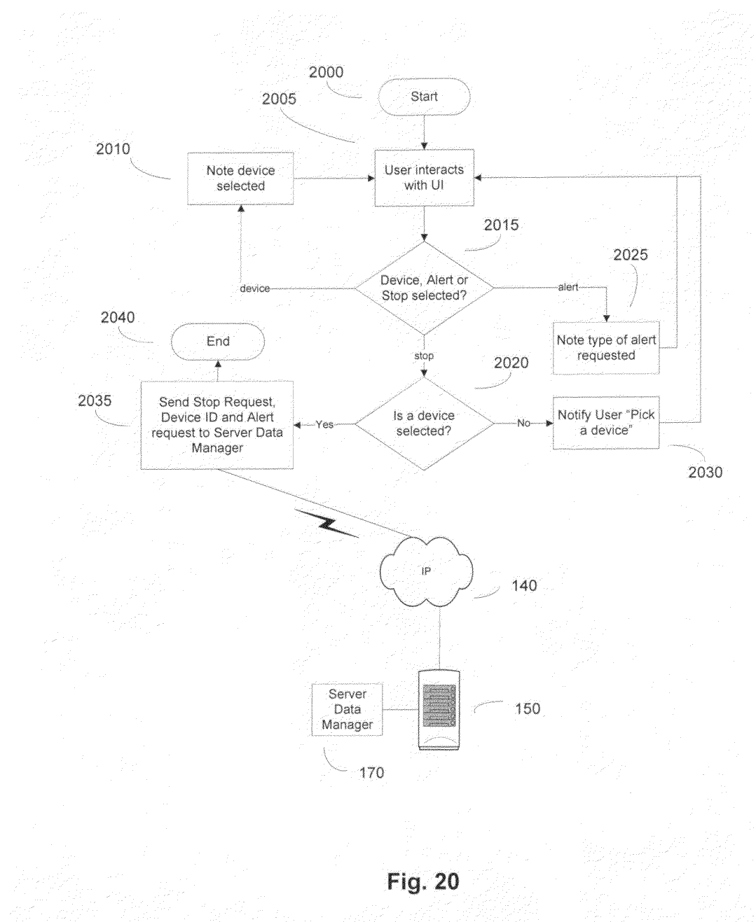

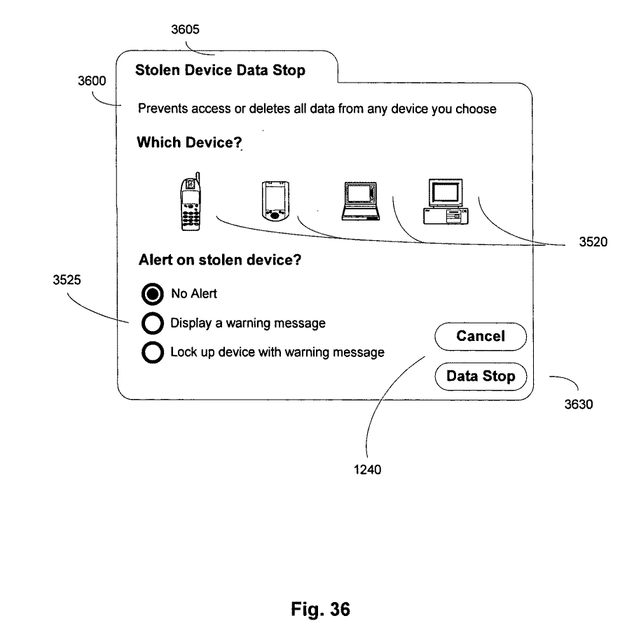

A unique feature of this file system is the ability of users to protect their data from prying eyes in case their device is stolen or lost. This stolen device data stop functionality is described in FIG. 20. Operation starts at 2000. The user interacts with the user interface 2005 (as seen in FIG. 36). The software checks to see if the user has selected a particular computational device 2015. If a device is selected, then that device is noted by the software 2010 and operation returns to 2005. If, instead, the user has selected “alert” then 2015 notes the type of alert selected 2025 returning control to 2005. If the user has selected the “stop” button the software verifies that a device was previous selected 2020, and if not it notifies the user they must select a device 2030 and control returns to 2005. If a device was indeed selected, then the software sends a stop request, device ID, and alert request to the server data manager 2035 via the Internet stream 140.

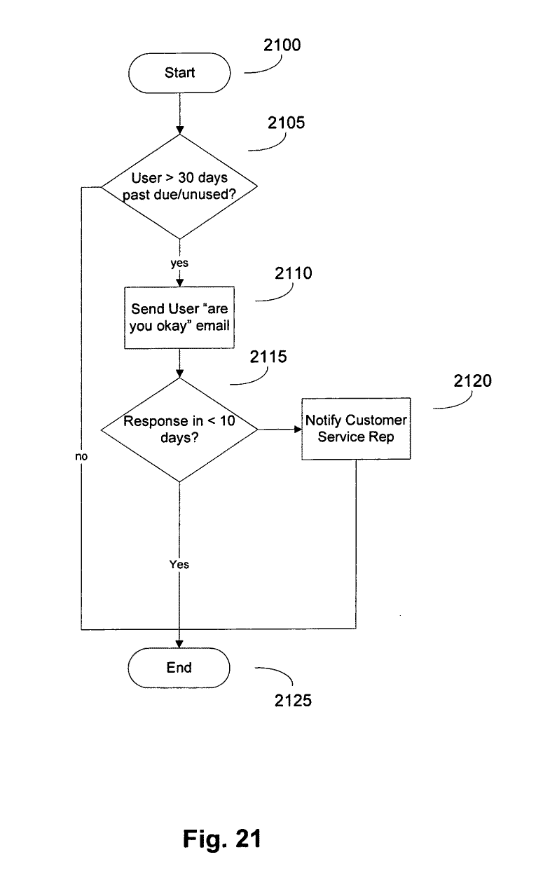

Another unique feature of this software system is the ability to deliver a user's data to the next of kin or other previously designated beneficiary upon a user's death. This data inheritance function is described in FIG. 21.

Function begins at 2100. The software checks to see if a user's payment is more than 30 days past due or if their account has not been accessed (by any registered device) in more than 30 days 2105. If the payment is current, and the user has used any registered device within 30 days then user function ends at 2125. If not, then the software system automatically sends the user an email message asking them to check in 2110. If that email is responded to in less than 10 days 2115 operation ends at 2125. However, if it is not, a customer service representative is alerted 2120 to contact the user and determine whether there has been a death and subsequently provide the next of kin or beneficiary access to the computer files.

Another unique feature of this software is the ability to restore a computing device to a previously known working condition should that device suffer a data loss failure or other malfunction of its primary storage medium (hard disk or EEPROM) or if that device has been replaced with a new device of the same type.

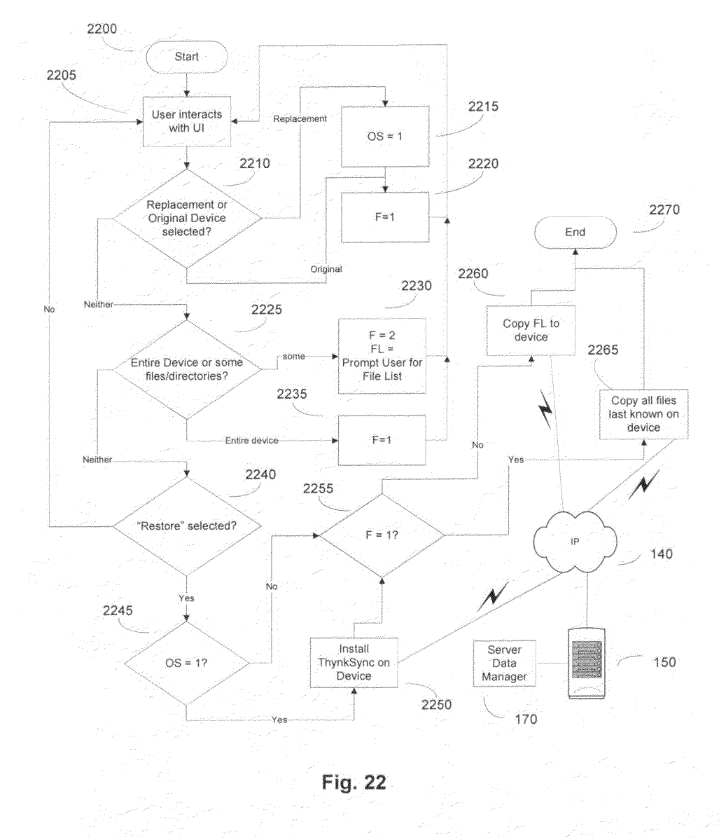

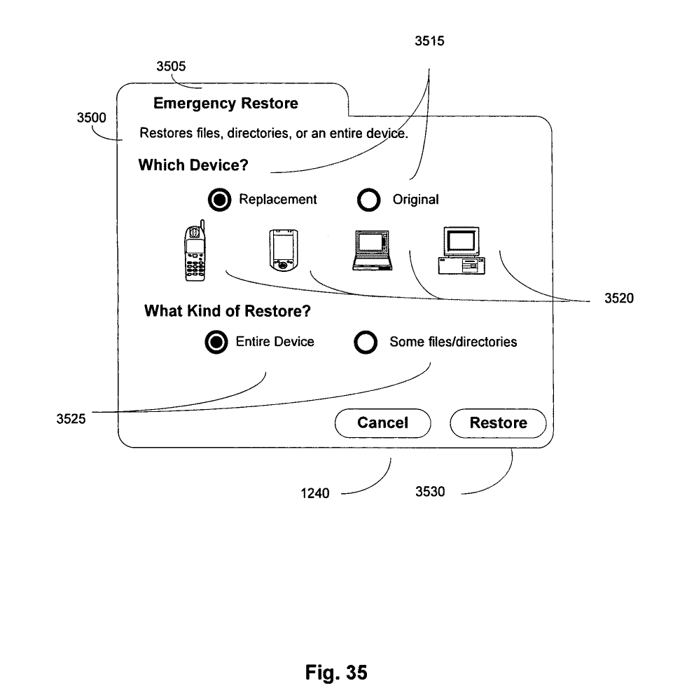

This emergency restore functionality is described in FIG. 22 and function begins at 2200. The user interacts with the user interface (illustrated in FIG. 35) 2205 and the software checks to see if the “restore” button has been selected 2240. If so, the code checks to see if the variable “OS” has been set to the numeric value of “one” 2245, which indicates that “replacement” was selected previously. If so the system knows that the software must be installed in addition to the files, so it installs the software system on the new device 2250 which it gets from the Internet stream 140. Then the software checks to see if the variable “F” is equal to the numeric value of “one” 2255, which means that the user has selected either “replacement” or “original” from the user interface in 2210, 2215 and 2220. If that is the case, or if 2245 resulted in a “no” response, the software system copies all known files to the device 2265. If “F” did not equal “one”, then only selected files from the file list “FL” are copied to the device and operation ends at 2270. Files are fetched from the Internet stream via 140 and the cloud-based Internet server.

After the user interacts with the user interface in 2205, the software determines if the user selected “replacement” or “original” from the user interface. If “replacement” is selected 2215 the value “OS” is set to the numeric value “one” and processing continues to 2220. If “original” is selected processing continues to 2220 where the variable “F” is assigned the numeric value of “one”.

After this the software checks to see if the user has selected “entire device” or “some files and directories” 2225. If “entire device” is selected then the variable “F” is assigned the numeric value of “one” and processing returns to 2205. If “some files/directories” is selected then the variable “F” is assigned the numeric value of “two”, and the user is prompted to select the files they would like restored with those values being placed in a file list “FL” 2230.

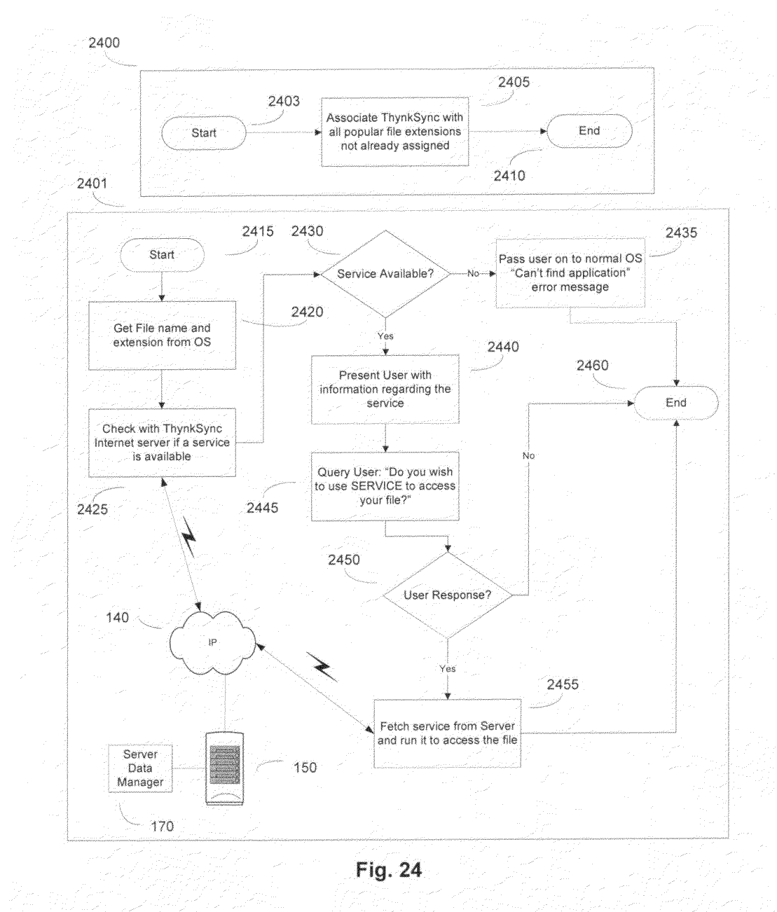

Inherent in this software system is the situation where a user, now having access to their data from any computing device, will have access to the file but not the application program which created it. For example, if the user created a file called “building blueprint.vsd” using Microsoft Visio, they might find themselves at a customer location on a rented laptop and, because that laptop does not have Visio installed on it, their file, although accessible, is useless. What's needed is a fast and small web based service or small footprint software application that can provide this basic access for opening, editing, viewing, and/or printing the file. This file open/edit/view assistance feature is described in FIG. 24. When the software is initially installed, an operation described in 2400 occurs. Starting at 2403 the software interfaces with the computing device's operating system to associate all popular file extensions that are currently not already assigned to other applications to the software package itself 2405. Then operation ceases at 2410.

Now, if a user opens a file that does not have an appropriate application, the software will attempt to assist as described in 2401. Operation begins at 2415. The software fetches the file name and extension from the operating system 2420 then, utilizing the Internet stream 140 the software checks with the cloud-based Internet server 150 to see if files with that extension are served by a file opening/viewing/editing/printing service 2425. If a service is available 2430, then the user is presented with the availability of the service, and that service's abilities 2440. The user is queried if they wish to use that service 2445. The software checks 2450 to see if their response is “yes” then the system fetches the service 2455 from the Internet stream 140 and the cloud-based Internet server 150 and then runs the service to open/view/edit or print that file with processing ending at 2460. If the user responds “no” at 2450, then the file is not opened/edited/viewed or printed and operation ends at 2460.

If a service is not available 2430 then the software hands the failure to open the file back to the operating system's normal “can't find application” error message and solution system 2435 and operation ends at 2460.

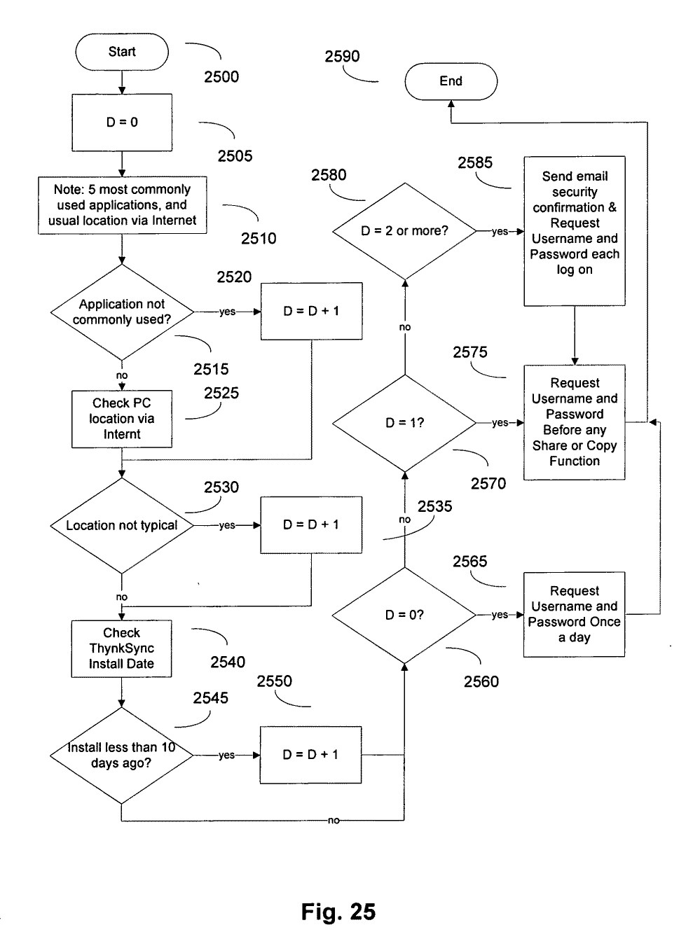

In order to understand FIG. 25 it's necessary to mention that this software system, like most secure systems, requires users to log in by typing in their user name and password when the software is initially installed in order to create an “account”. However, in order to allow only secure access to the data it is prudent to periodically ask the user to re-enter their user name and password in case that computing device is lost or stolen and falls into the wrong hands. It would be annoying to ask user to type in their user name and password each time they startup their computing device, so a security check trigger system has been created to only request username and password under certain circumstances and that system is described in FIG. 25.

Functionality begins at 2500. The variable “D”, the “risk factor”, is assigned the numeric value of “zero” 2505. The computer then notes the five most commonly used applications on that computing device and checks to see which locations on the Internet are most often accessed 2510. Then as the computing device is used, the software checks to see if an application that is not commonly used is being used 2515. If so, the variable “D” is incremented by “one” 2520. Then the computer checks the computing device's current physical location via the Internet IP lookup, or via the mobile device's built in global positioning system or cell tower triangulation 2525. If the software finds that the computing device is not in the typical locations of that device, the variable “D” is incremented by “one” 2535.

Lastly, the software checks to see when the ThynkSync software was installed on the computing device 2540. If the software was installed less than ten days ago 2545, then the variable “D” is incremented by “one” 2550.

Finally the software checks the value of the variable “D”. If the value is “zero” 2560 then the software requests the username and password from the user one time each day 2565. If the variable “D” is equal to “one” 2570, then the software requests the user name and password from user before any share or copy function 2575. If the value of the variable “D” is equal to or greater than “two” 2580, then the software sends the user an email security confirmation and begins requesting the user to enter their user name and password with each log-on 2585 and function is passed onto 2575. Function ends at 2590. This security function will cease once user has updated their profile to reflect their new address.

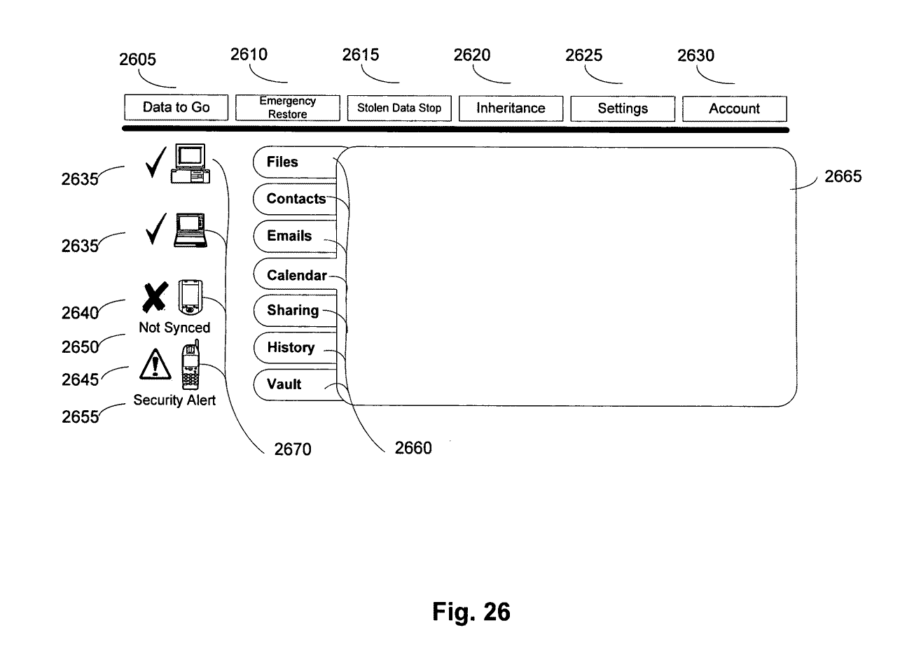

Although operation of the software is fundamentally invisible to the user, a user may wish to access their information via the Internet in order to make adjustments, change permissions, or to access their data should they not have access to one of their own personal computing devices. For this reason a web site interface and screen maps are provided and described in FIGS. 26 through 39.

FIG. 26 does not feature a representation of the web browser but is exploded to allow a description of the basic elements that exist in the future figures. Referring now to FIG. 26, across the top of the window is a strip of buttons giving access to features of the system, including “data to go” 2605, “emergency restore” 2610, “stolen device data stop” 2615 “inheritance” 2620 “settings” 2625, and finally “account” 2630, and if the user selects any of them, pop-up sub-windows open (as seen in FIGS. 34-39).

Along the left side are iconic representations of the user's registered computation devices including a desktop computer, a laptop computer, a tablet computer and a cell phone 2670. All of these devices have had the software installed on them and can access the user's data universally.

The check mark 2635 indicates that these devices are fully synchronized and are interfacing normally with the software. The “x” mark 2640 indicates a problem, and as the text 2650 indicates, this device has not been synced. The cell phone features an alert icon 2645 which indicates a serious problem which is described in 2655 which means that the security of that device has been compromised and action is required.

To the right of the device icons is a large tabbed 2660 window 2665 capable of showing information for any selected tab.

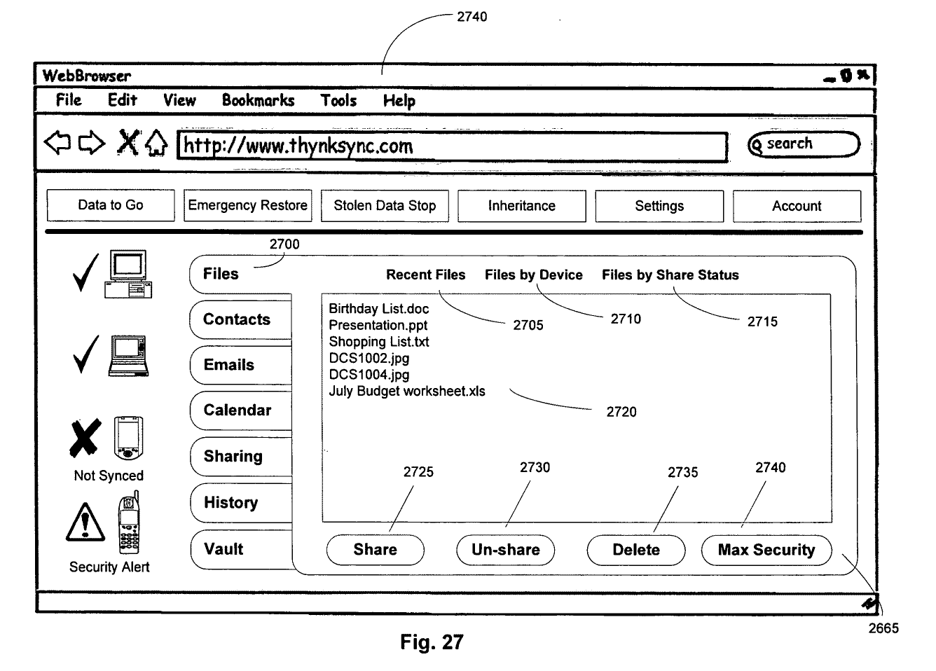

Referring now to FIG. 27, an exemplary Internet browser is represented 2740. The “file” tab 2700 has been selected by the user. Across the top of the tabbed window 2665 are commands that apply to the items listed, which in this case are computer files handled by the software system. Files may be displayed by most recently accessed 2705, categorized by the device they were created on 2710, or listed by share status 2715. The list is shown on 2720. Additionally any file can be selected by the user, and one of the commands across the bottom of the window may be selected including “share” 2725 which opens another window allowing the user to add people to the share list, “un-share” 2730 which allows the user to remove sharing privileges, “delete” 2735 which marks the files for deletion (from all devices and the Internet server), and finally “max security” 2740 which causes the file to receive double encryption if it has never been shared.

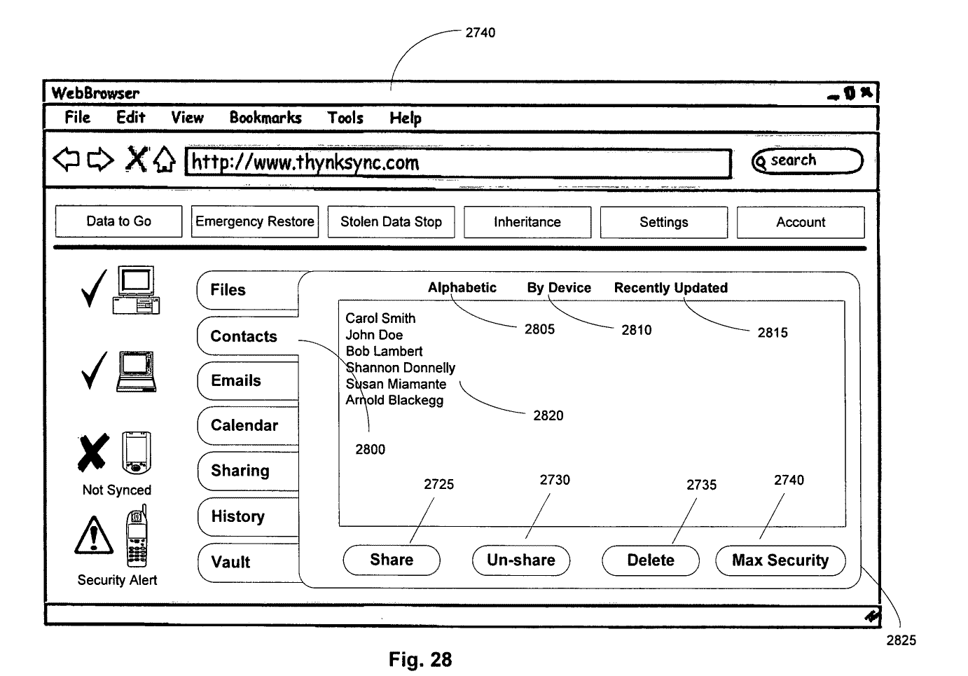

In FIG. 28 we see the “contacts” tab opened 2800. Across the top of the tabbed window 2825 are commands that apply to the items listed, which in this case are contacts handled by the software system. Contacts may be displayed in alphabetical order 2805, by computation device of origin 2810, or by how recently they were updated 2815. The list is shown on 2820. Additionally any contact can be selected by the user and one of the commands across the bottom of the windows may be selected including “share” 2725 which opens another window allowing the user to add people to the share list, “un-share” 2730 which allows the user to remove sharing privileges, “delete” 2735 which marks the contact for deletion (from all devices and the Internet server), and finally “max security” 2740 which causes the contact to receive double encryption.

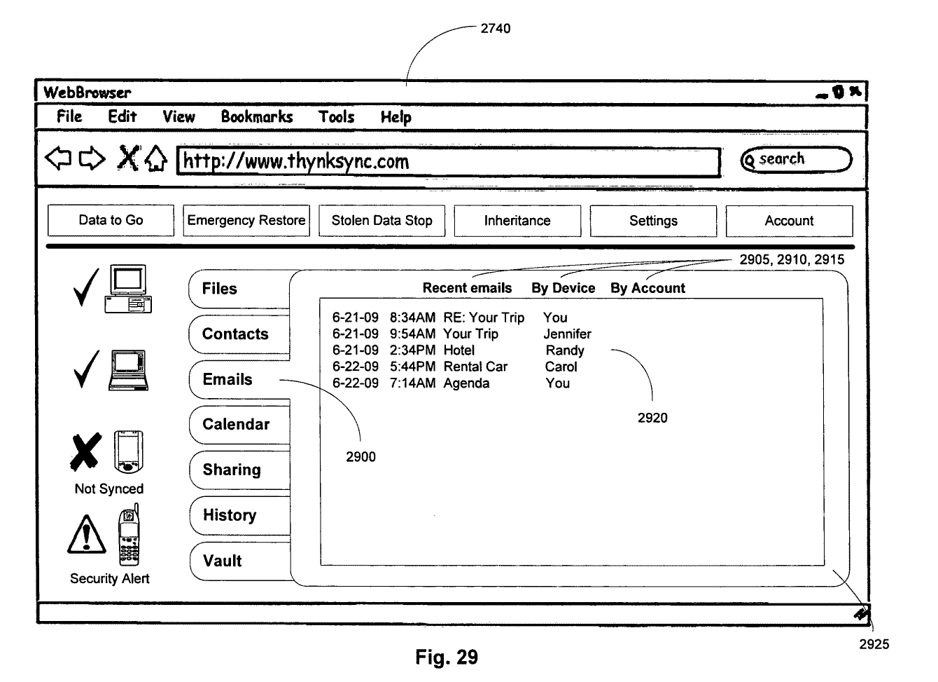

In FIG. 29 we see the “emails” tab opened 2900. Across the top of the tabbed window 2925 are commands that apply to the items listed, which in this case are recent mails 2905, by device 2910, by account 2915. The list is displayed 2920.

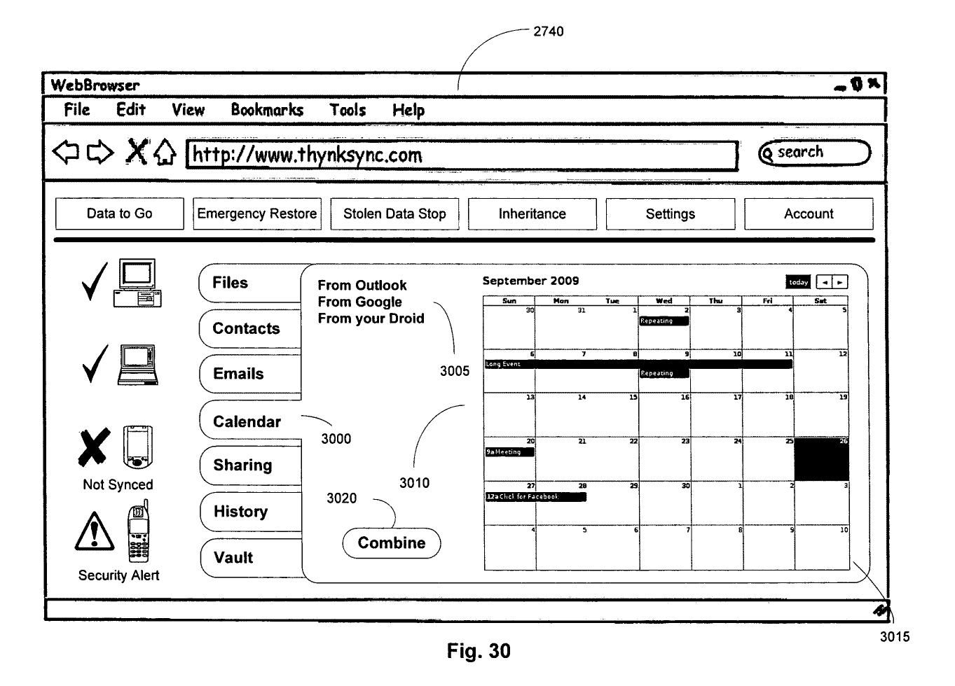

In FIG. 30 we see the “calendar” tab opened 3000. On the left side of the window are commands that allow the display of various calendar options that the user might have 3005. In this case “from outlook” shows the user's outlook calendar, “from Google” shows the user's Google calendar, and “from your Droid” shows the user's Droid smart phone calendar. The calendar is displayed in 3010. Additionally the user may click on the “combine” button 3020 which combines all of the user's calendar entries into one master calendar which synchronizes/replaces the individual calendars.

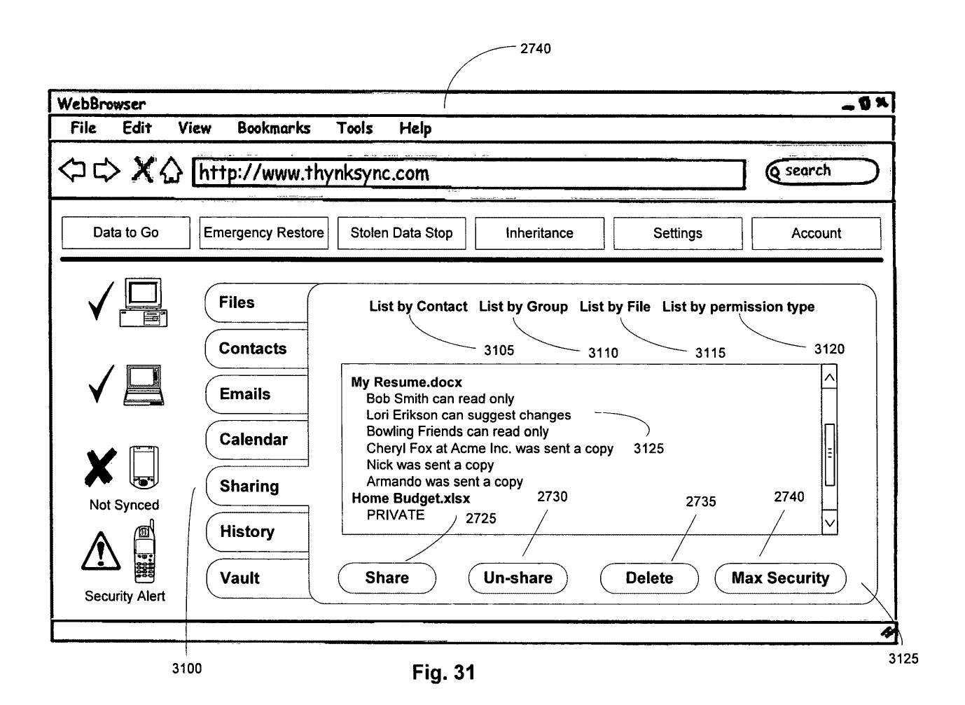

In FIG. 31 we see the “sharing” tab opened 3100 which lists files and their sharing info. Across the top of the tabbed window 3125 are commands that apply to the items listed, which in this case are files and their sharing info which are handled by the software system. Files and their sharing info may be displayed by contact 3105, by group 3110, by file 3115 and finally by permission type 3120. The list is shown on 3125. Additionally any file can be selected by the user, and one of the commands across the bottom of the windows may be selected, including “share” 2725 which opens another window allowing the user to add people to the share list, “un-share” 2730 which allows the user to remove any contact's sharing privilege, “delete” 2735 which deletes the sharing permission or file (from all devices and the Internet server), and finally “max security” 2740 which causes the file to receive double encryption

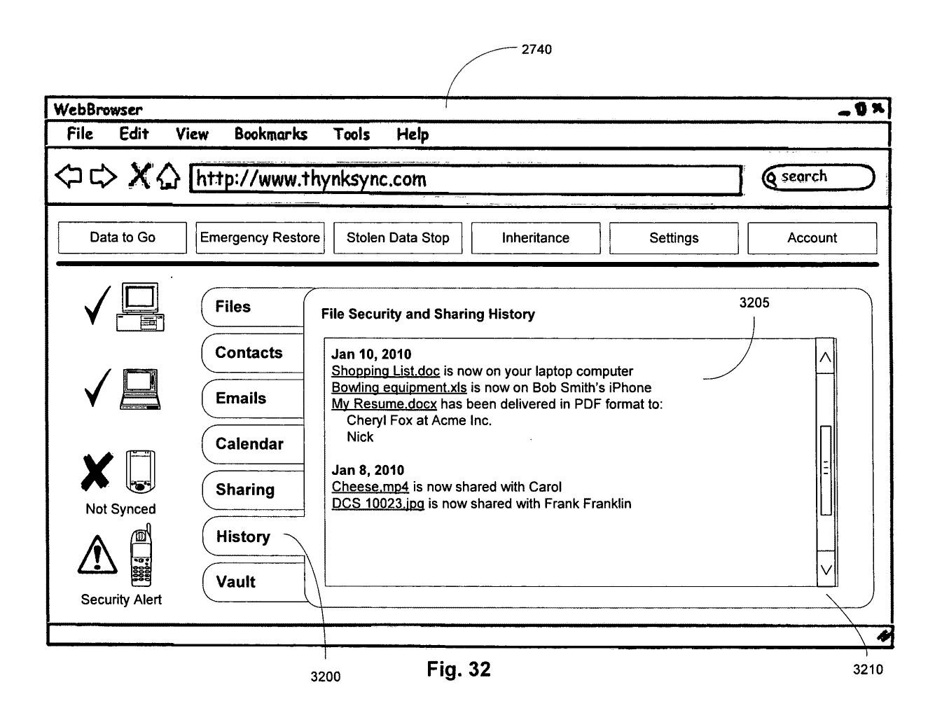

In FIG. 32 we see the “history” tab opened 3200 which lists file security and sharing history 3205. This window displays information only.

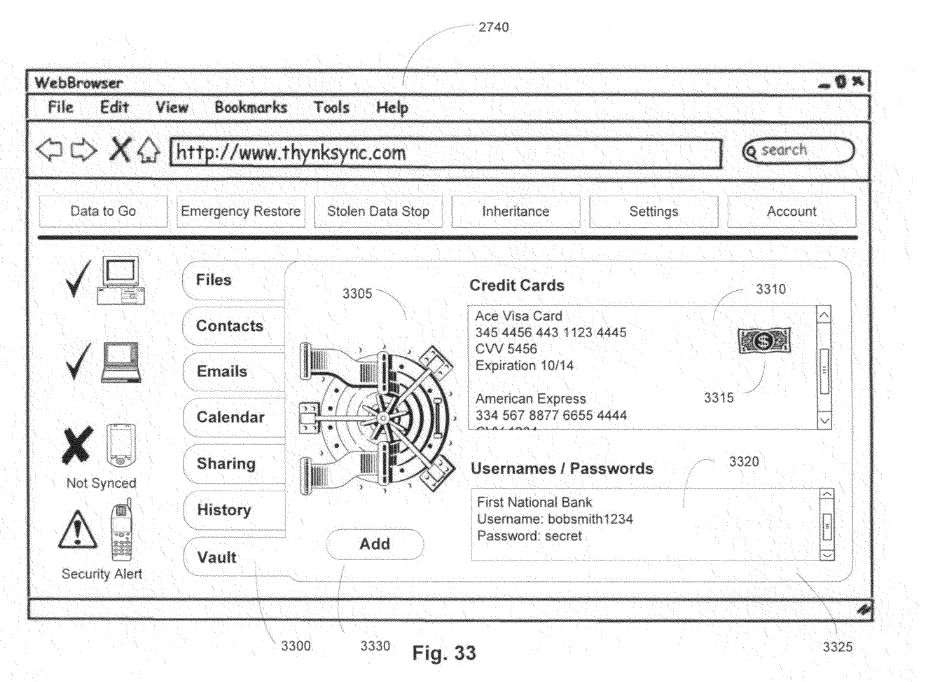

In FIG. 33 we see the “vault” window opened 3300. The purpose is to display the information stored in the software system's “vault” high security area. A graphic representation of a bank vault 3305 is displayed to alert the user to the secure nature of this area. Credit card information is stored in sub-window 3310. One credit card is marked with the “money” icon 3315 indicating which credit card is used to pay for the software service. User names and passwords are displayed in sub-window 3320. Also featured is an “add” button 3330 which allows a user to add or upload files or information into the “vault” area. Note that any file can be stored in the vault area, not just credit cards or usernames and passwords.

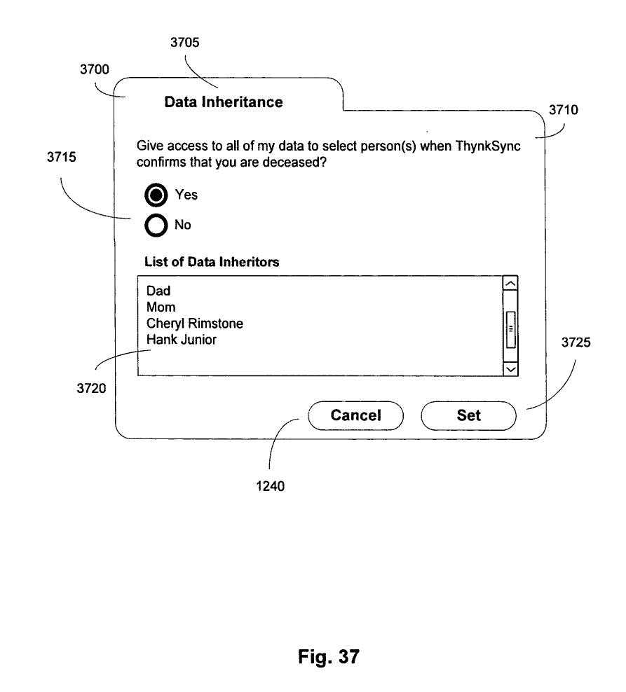

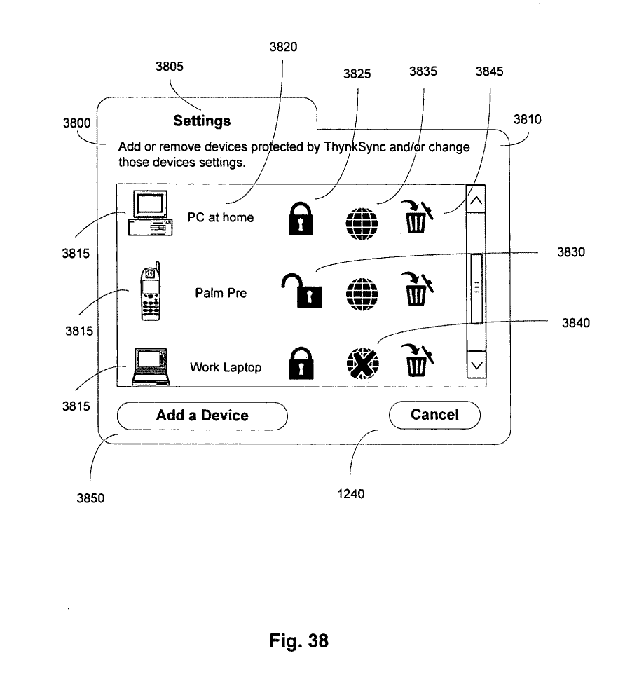

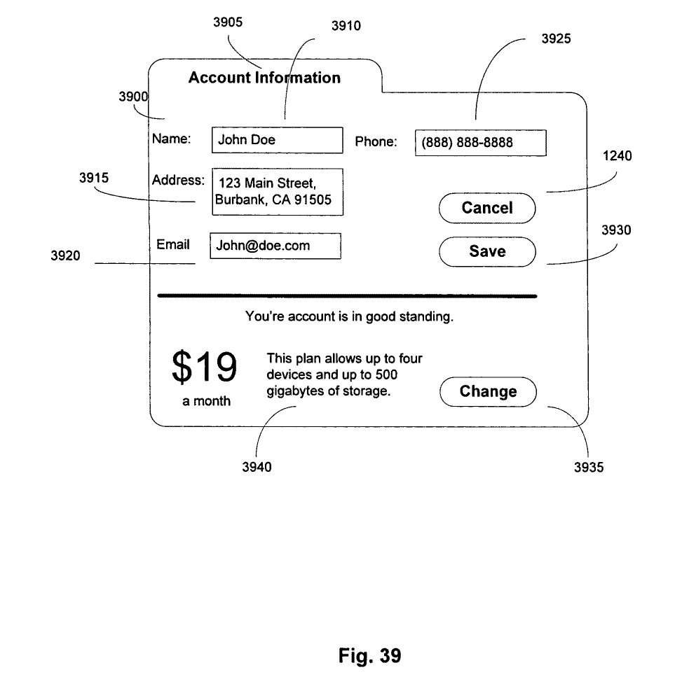

Referring now to FIG. 26, across the top of the window is a strip of buttons giving access to features of the system, including “data to go” 2605 (FIG. 34), “emergency restore” 2610 (FIG. 35), “stolen device data stop” 2615 (FIG. 36), “inheritance” 2620 (FIG. 37), “settings” 2625 (FIG. 38), and finally “account” 2630 (FIG. 39), and if the user selects any of the buttons, pop-up sub-windows open.

Referring now to FIG. 34, the pop-up sub-window for “data to go” is illustrated 3400. The title is shown 3405. Instructions are displayed 3410. The user can select any of the displayed devices with available storage mediums 3415, including flash drive, CD-ROM or DVD-ROM, cell phone with file storage feature, tablet PC or PDA, or laptop computer. In window 3420 the user can select any files they wish to copy to that device via OS specific file selection system. When the user is ready they may select the “create” button 3425 or change their mind and select “cancel” 1240.

Referring now to FIG. 35, the pop-up sub-window for “emergency restore” is illustrated 3500. The title is shown 3505. Using “radio buttons”, the user may select “replacement” or “original” 3515, and which of their registered computational devices requires restoration 3520 by clicking on it. Then the user can, using the “radio buttons”, select “entire device” or “some files/directories” 3525. When the user is ready they may select the “restore” button 3530 or change their mind and select “cancel” 1240.

Referring now to FIG. 36, the pop-up sub-window for “stolen device data stop” is illustrated in 3600. The title is shown in 3605. The user can select which of their registered computational devices is affected 3520 by clicking on it. Then the user can, using the “radio buttons”, select an alert option, “no alert”, “display a warning message”, or “lock up device and display a warning message” 3525. When the user is ready they may select the “data stop” button 3630 or change their mind and select “cancel” 1240.

Referring now to FIG. 37, the pop-up sub-window for “data inheritance” is illustrated in 3700. The title is shown in 3705. Instructions are displayed in 3710. Then the user can, using the “radio buttons”, select “yes” to enable data inheritance or “no” to disable inheritance 3715. The user can then specify in a window 3720 which persons will receive their data when the user is deceased. When the user is ready they may select the “set” button 3725 or change their mind and select “cancel” 1240.

Referring now to FIG. 38, the pop-up sub-window for “settings” is illustrated in 3800. The title is shown in 3805. Instructions are displayed in 3810. In a sub-window is a list of the user's registered computational devices 3815, described at 3820. Each device has an associated locked 3825 or unlocked 3830 icon, is connected to the Internet server (FIG. 1 150) 3835 or not connected 3840, or a “trash can” command which allows the user to remove that device from the service 3845. When the user is ready they may select the “add a device” button 3850 to add an additional computational device, or change their mind and select “cancel” 1240.

Referring now to FIG. 39, the pop-up sub-window for “account information” is illustrated 3900. The title is shown 3905. The user's name is displayed 3910 and the user may change this information. The user's address is displayed 3915, their email address is displayed 3920 was missing, their phone number is displayed 3925. The user may make changes to any of these fields and select the “save” button 3930, or change their mind and select “cancel” 1240. Also on in this window is information on the user's current account plan 3940 which they can change by selecting the “change” button 3935.

### ADVANTAGES

The advantages of the present invention include, without limitation:
A single solution to protect, share, send and aggregate their data to multiple persons across multiple devices.
All data emanates from a single location, so struggling with multiple versions, incomplete or inconsistent calendars and contact data is averted completely.
Sending data, typically done with file attachments, is replaced by simply selecting a contact or contacts associated with a file or group of files (folder). Rather than sending the data, a slow process, that contact simply is granted permission to receive that file.
Safe storage of the data on secure servers via the Internet, encrypting data as it is stored and during transport, making the data more secure in general, but also ensuring that theft of their devices or loss of functionality (hard disk crash) will no longer be a time consuming and expensive problem to resolve or require a special service or effort from the user.
The ability to easily share their data with any person or group, without lengthy upload/download time, or the need to join one or multiple file sharing services.
The ability for a person to automatically have their data, often representing valuable assets such as tax information, wills, account information, etc to be transferred to a designated beneficiary after their passing.
The ability to protect their data from theft via the “stolen data stop” feature which can stop all access to the data, and even lock the device, rendering it useless.
The ability to copy the data from the cloud-based storage to a physical data storage device, such as a DVD-ROM, USB flash drive, etc to allow access to data when Internet access is not available or practical.
Use and location sensitive log-in security that only requires the user to log in if their device is found to be in suspicious use or locations.
The ability for users to restore some files, or an entire copy of their device (back-up “restore”) if a device is stolen, damaged, or unavailable.
The ability to use data from a restored device even without access to or the need to reinstall applications and programs that created those files.
The ability to safely store data normally not stored on computers with the highly secure “vault” feature. Using double encryption, the Vault is a safe place to store information such as credit card numbers, safe combinations, bank account balances, etc.

### In Broad Embodiment

In broad embodiment, the present invention is a software/Internet solution that completely, automatically, and transparently aggregates, shares, backs-up, sends and protects everything a person does on their personal or work computers and mobile devices.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

The embodiments of the invention in which an exclusive property or privilege is claimed are defined as follows:

1. A computer file management system for the storage, sharing, delivering and aggregating of files via Internet cloud storage to multiple computing devices, comprising:
a file interceptor which transparently intercepts normal operating system file operations;
a master file manager which maintains an encrypted link to the cloud-based web server via wired or wireless Internet connection;
a file manager file handler which queues files for background transmission back and forth from the device and the cloud-based web server, caches the files, or hands control of the file back to the device's normal operating system;
a command handler which executes special commands which are unique to this system but outside the normal capabilities of the device's OS;
a file maintainer which manages hard disk or RAM caches and the background sending and receiving of files; a connect manager which sends or receives files via the encrypted Internet link to the cloud-based web server and manages connect, disconnect and incomplete file send situations;
a server data manager which stores and retrieves the user's data on the cloud-based server storage devices, and depending on the frequency of data access, stores that data in slow or fast storage devices;
a shutdown postponer which alerts the user if their work has not yet been sent to the web-based cloud server if that user attempts to shut down the device;
a file determiner which manages the additional file data required by this system but is not normal to the device's OS;
a local user interface which allows access to the special features and parameters of the system;
a web based user interface allows access to special features and the files themselves via Internet web browser.

2. A computer file management system as set forth in claim 1, wherein files managed by the system appear to be stored locally, yet are actually stored as a single file on a cloud-based Internet server, and can be accessed by any device running the computer file management system.

3. A computer file management system as set forth in claim 2, wherein files managed by the system can be accessed and manipulated by anyone using the system provided they are given permission by the file's creator, thus creating the same result as sending a file via email attachment.

4. A computer file management system as set forth in claim 2, wherein all files on a device running the system are stored on a cloud-based Internet server, from most to least accessed, creating a complete system backup over time.

5. A computer file management system as set forth in claim 4, wherein all files eventually being stored on the cloud-based Internet server can, upon command by the user, be restored in full or in part, acting as a backup restore function for any device.

6. A computer file management system as set forth in claim 1, wherein all files are intercepted, evaluated, and stored on a computer file management system and thusly contact information from various devices, computer programs and online services can be aggregated to create one master set of contacts which transparently appear on all user devices.

7. A computer file management system as set forth in claim 1, wherein all files are intercepted, evaluated, and stored on a computer file management system and thusly calendar information from various devices, computer programs and online services can be aggregated to create one master calendar which transparently appears on all user devices.

8. A computer file management system as set forth in claim 1 which, when activated by the user, can halt the process of transferring data back and forth from the device to the cloud-based Internet server, thus protecting that data from unauthorized access.

9. A computer file management system as set forth in claim 8 which, having halted the process of transferring data back and forth from the device to the cloud-based Internet server upon a user command, can additionally display a warning message to the thief, and/or completely stop the device from operating thus rendering it useless.

10. A computer file management system as set forth in claim 1 which can copy the data stored on the cloud based Internet server onto discrete physical media in order to allow it to be accessed when no Internet connection is available.

11. A computer file management system as set forth in claim 1, which detects various conditions thus automatically changing its user authentication parameters so that authorized users require little or no authentication, and likely thieves are required to provide extensive authorization.

12. A computer file management system as set forth in claim 4 which, after restoring data to new device, or one which has suffered data loss, will locate and initiate software tools to allow the user to access that data without requiring them to re-install the original applications used to create those files.

13. A computer file management system as set forth in claim 1, which offers a second layer of encryption and file storage security on the cloud-based Internet server which allows the apparent local storage of highly confidential information normally not trusted to a computer device which is easily stolen or lost.

14. A method for utilizing a user interface presented on the individual device's operating system allowing access to special features and parameters of the system.

15. A method for accessing the user's files stored on the web based Internet server, and the special features and parameters of the system via a website available on any Internet connected device via web browser.
